(19) United States
(12) Patent Application Publication
(10) Pub. No.: US 2026/0189368 A1
(43) Pub. Date: Jul. 2, 2026

(54) BLOCKCHAIN KEY-BASED DATA PROCESSING METHOD AND APPARATUS, DEVICE, AND STORAGE MEDIUM

(71) Applicant: TENCENT TECHNOLOGY (SHENZHEN) COMPANY LIMITED, Shenzhen (CN)

(72) Inventors: Hu LAN, Shenzhen (CN); Jun LIANG, Shenzhen (CN); Like SHU, Shenzhen (CN); Shitao XU, Shenzhen (CN); Chaojie QI, Shenzhen (CN); Zongyou WANG, Shenzhen (CN); Yang LU, Shenzhen (CN); Yifang SHI, Shenzhen (CN); Gengliang ZHU, Shenzhen (CN); Hanqing LIU, Shenzhen (CN); Qucheng LIU, Shenzhen (CN); Zhiyong LIAO, Shenzhen (CN); Yangjun HUANG, Shenzhen (CN); Zuodong LIANG, Shenzhen (CN); Guihong HUANG, Shenzhen (CN); Hui ZHANG, Shenzhen (CN); Yang MO, Shenzhen (CN); Zimin CHEN, Shenzhen (CN); Lisen LI, Shenzhen (CN); Tao FAN, Shenzhen (CN)

(21) Appl. No.: 19/320,881

(22) Filed: Sep. 5, 2025

Related U.S. Application Data
(63) Continuation of application No. PCT/CN2024/101223, filed on Jun. 25, 2024.

(30) Foreign Application Priority Data
Aug. 9, 2023 (CN) 202310997066.1

(51) Int. Cl. H04L 9/08; H04L 9/00; H04L 9/14; H04L 9/30; H04L 9/32

(52) U.S. Cl. CPC H04L 9/0825; H04L 9/0869; H04L 9/14; H04L 9/30; H04L 9/3236; H04L 9/3247; H04L 9/50

(57) ABSTRACT

Embodiments of this application disclose a blockchain key-based data processing method and apparatus. The method includes obtaining communication channels respectively communicating with N clients, and respectively performing key shard negotiation with the N clients to obtain a local private key shard and a complete public key; receiving signature requests transmitted by M−1 clients in the N clients, and obtaining identity association information in the M−1 signature requests; if the identity association information in the M−1 signature requests is legitimate identity information, determining a client that is in the M−1 clients as a target client, and obtaining service execution data associated with the target client; and if the service execution data conforms to a risk management policy corresponding to identity association information of the target client, jointly participating in joint signature processing on the blockchain service with the M−1 clients.

### RELATED APPLICATIONS

This application is a continuation of PCT Application No. PCT/CN2024/101223, filed on Jun. 25, 2024, which in turn claims priority to Chinese Patent Application No. 202310997066.1, entitled “BLOCKCHAIN KEY-BASED DATA PROCESSING METHOD AND APPARATUS, DEVICE, AND STORAGE MEDIUM” and filed with the China National Intellectual Property Administration on Aug. 9, 2023, which are incorporated herein by reference in their entirety.

### FIELD OF THE TECHNOLOGY

This application relates to the field of blockchain technologies, and in particular, to a blockchain key-based data processing method and apparatus, a device, and a storage medium. The method is mainly related to a digital asset management technology, and signature processing is implemented by using a key management method and a key use method.

### BACKGROUND OF THE DISCLOSURE

Currently, with the development of blockchain technologies, digital assets are applied more widely. Because during service interaction, signature processing needs to be performed on a digital asset by using a corresponding key, if service interaction needs to be successfully performed, a secure and stable signature key needs to be generated for the digital asset. In a current key generation method, a pair of public and private keys is usually generated by using an algorithm, then encryption is performed by using the private key, and decryption is performed by using the public key corresponding to the private key. When the private key is broken or lost, the digital asset cannot be used. Therefore, the currently used key signature method increases a risk probability when the digital asset is used.

### SUMMARY

Embodiments of this application provide a blockchain key-based data processing method and apparatus, a device, and a storage medium, which can reduce a risk probability when a digital asset is used.

One aspect of the embodiments of this application provides a blockchain key-based data processing method, including obtaining communication channels respectively communicating with N clients, and respectively performing key shard negotiation with the N clients based on the N communication channels, to obtain a local private key shard and a complete public key, N being a positive integer greater than 1, the complete public key being a unique public key corresponding to the local private key shard and N target private key shards, and an ith target private key shard in the N target private key shards being a private key shard held by an ith client in the N clients after the key shard negotiation; receiving signature requests transmitted by M−1 clients in the N clients, and obtaining identity association information in the M−1 signature requests, M being a quantity threshold of private key shard for performing signature verification based on the complete public key, and M being a positive integer less than or equal to N+1; if the identity association information in the M−1 signature requests is legitimate identity information, determining a client that is in the M−1 clients and that is configured to initiate a blockchain service as a target client, and obtaining service execution data associated with the target client; and if the service execution data conforms to a risk management policy corresponding to identity association information of the target client, jointly participating in joint signature processing on the blockchain service with the M−1 clients, a joint signature result being generated based on both the local private key shard and target private key shards respectively held by the M−1 clients, and the joint signature result being configured for the target client to execute the blockchain service.

Another aspect of the embodiments of this application provides a blockchain key-based data processing method, performed by a target client configured to initiate a blockchain service and the method including obtaining, by the target client, communication channels respectively communicating with N−1 clients and a server end, and performing key shard negotiation with the server end and the N−1 clients based on the communication channels, to obtain a target private key shard corresponding to the target client and a complete public key, N being a positive integer greater than 1, the complete public key being a unique public key to which the target private key shard corresponding to the target client, a server end private key shard, and target private key shards corresponding to the N−1 clients jointly correspond, an ith target private key shard in the target private key shards corresponding to the N−1 clients being a private key shard held by an ith client in the N−1 clients after the key shard negotiation, and the server end private key shard being a private key shard held by the server end after the key shard negotiation; generating, based on identity association information corresponding to the target client, a signature request corresponding to the target client, and transmitting the signature request corresponding to the target client to the server end, so that the server end performs legitimate identity verification on identity association information in received M−1 signature requests, the M−1 signature requests comprising the signature request corresponding to the target client, and M being a quantity threshold of private key shard for performing signature verification based on the complete public key, and M being a positive integer less than or equal to N+1; if the server end determines that the identity association information in the M−1 signature requests is legitimate identity information, transmitting service execution data associated with the target client to the server end; and if the service execution data conforms to a risk management policy corresponding to the identity association information of the target client, jointly participating in joint signature processing on the blockchain service with a client that initiates a signature request and the server end, a joint signature result generated through the joint signature processing being generated based on both a target private key shard that corresponds to the client that initiates the signature request and the server end private key shard, and the joint signature result being configured for being provided for the target client to execute the blockchain service.

Another aspect of the embodiments of this application provides a computer device, comprising a processor, a memory, and a network interface the processor being connected to the memory and the network interface, the network interface being configured to provide a data communication function, the memory being configured to store a computer program, and the processor being configured to invoke the computer program, to enable the computer device to perform a blockchain key-based data processing method in some embodiments.

Another aspect of this application provides a non-transitory computer-readable storage medium. The computer-readable storage medium stores a computer program. The computer program is suitable to be loaded and executed by a processor, to perform the method in the embodiments of this application.

In some embodiments consistent with the present application, communication channels respectively communicating with N clients are obtained, and key shard negotiation is respectively performed with the N clients based on the N communication channels, to obtain a local private key shard and a complete public key. N is a positive integer greater than 1. Specifically, the complete public key is a unique public key to which the local private key shard and N target private key shards jointly correspond. An i^{th} target private key shard in the N target private key shards is a private key shard held by an i^{th} client in the N clients after the key shard negotiation.

Further, signature requests transmitted by M−1 clients in the N clients are received, and identity association information in the M−1 signature requests is obtained. Mis a quantity threshold of private key shard for performing signature verification based on the complete public key, and M is a positive integer less than or equal to N+1. Further, if the identity association information in the M−1 signature requests is legitimate identity information, a client that is in the M−1 clients and that is configured to initiate a blockchain service is determined as a target client, and service execution data associated with the target client is obtained. Further, if the service execution data conforms to a risk management policy corresponding to identity association information of the target client, joint signature processing is jointly performed on the blockchain service with the M−1 clients. A joint signature result generated through the joint signature processing is generated based on both the local private key shard and target private key shards respectively held by the M−1 clients, and the joint signature result is configured for being provided for the target client to execute the blockchain service.

In some embodiments, a local private key shard and a target private key shard are obtained through key shard negotiation, and verification is performed on identity association information of a client or a server end that participates in signature. After the identity association information is verified as legitimate identity information, joint signature processing is performed on multi-end private key shards, and one private key is no longer used alone to perform signature processing on a digital asset, so that a probability of a signature error cause by a private key problem is reduced. In other words, when private key shards in some clients or servers are unavailable, a signature function can still be implemented by using other M available private key shards, to improve a security probability of a digital asset signature, that is, reduce a risk probability when a digital asset is used. In addition, legal detection on the identity association information and application of the risk management policy can reduce risk of performing digital asset service interaction, and improve security of performing digital asset service interaction.

### BRIEF DESCRIPTION OF THE DRAWINGS

To describe the technical solutions in some embodiments or the related art more clearly, the accompanying drawings required for describing the embodiments or the related art are briefly introduced below. Apparently, the accompanying drawings in the following description show merely some embodiments of this application, and a person of ordinary skill in the art may still derive other drawings from these accompanying drawings without creative efforts.

FIG. 1 is a schematic structural diagram of a blockchain network according to an embodiment of this application.

FIG. 2 is a schematic diagram of a scenario of a digital asset signature according to an embodiment of this application.

FIG. 3 is a schematic flowchart of a data processing method according to an embodiment of this application.

FIG. 4 is a schematic flowchart of another data processing method according to an embodiment of this application.

FIG. 5 is a schematic diagram of an interface of a target client according to an embodiment of this application.

FIG. 6 is an interaction flowchart of a digital asset signature according to an embodiment of this application.

FIG. 7 is a schematic structural diagram of a data processing apparatus according to an embodiment of this application.

FIG. 8 is a schematic structural diagram of another data processing apparatus according to an embodiment of this application.

FIG. 9 is a schematic structural diagram of a computer device according to an embodiment of this application.

### DESCRIPTION OF EMBODIMENTS

The technical solutions in embodiments of this application are clearly and completely described in the following with reference to the accompanying drawings in some embodiments. Apparently, the described embodiments are merely some rather than all of the embodiments of this application. All other embodiments obtained by a person of ordinary skill in the art based on the embodiments of this application without making creative efforts shall fall within the protection scope of this application.

In a one embodiment of this application, relevant data (for example, payment data) of an object or a user is involved. When the following embodiments of this application are applied to specific products or technologies, permission or consent of the user needs to be obtained, and collection, use, and processing of the relevant data need to comply with relevant laws, regulations, and standards of relevant countries and regions.

The solutions provided in some embodiments relate to a blockchain technology, and are specifically described by using the following embodiments.

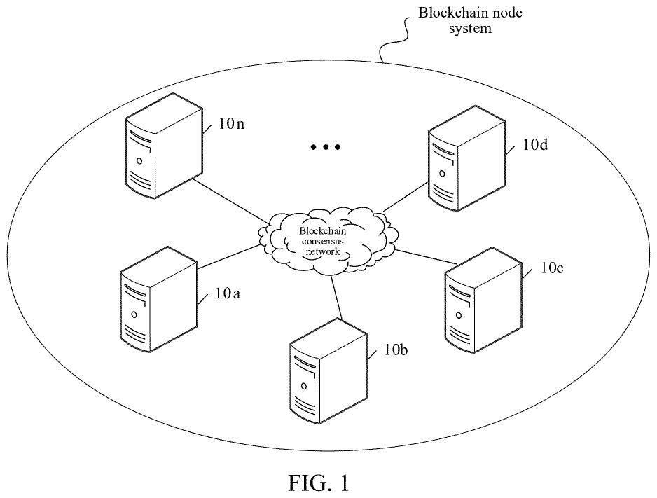

Referring to FIG. 1, FIG. 1 is a schematic structural diagram of a blockchain network according to an embodiment of this application. The blockchain network shown in FIG. 1 may include but is not limited to a distributed network corresponding to a blockchain service. The blockchain network may include a plurality of blockchain nodes. The plurality of blockchain nodes may specifically include a blockchain node 10a, a blockchain node 10b, a blockchain node 10c, a blockchain node 10d, . . . , and a blockchain node 10n. For example, the blockchain node may be a client or a server end in the distributed network corresponding to the blockchain service. During normal operation, each blockchain node may receive data transmitted from outside and perform block uploading processing based on the received data, or may transmit data to the outside. To ensure intercommunication of data between the blockchain nodes, there may be a data connection between the blockchain nodes. For example, there is a data connection between the blockchain node 10a and the blockchain node 10b, there is a data connection between the blockchain node 10a and the blockchain node 10c, and there is a data connection between the blockchain node 10b and the blockchain node 10c.

Data or block transmission may be performed between the blockchain nodes through the data connection. The blockchain network may implement the data connection between the blockchain nodes based on node identifiers. Each blockchain node in the blockchain network has a corresponding node identifier, and each blockchain node may store a node identifier of another blockchain node having a connection relationship with the blockchain node, to subsequently broadcast obtained data or a generated block to the another blockchain node based on the node identifier of the another blockchain node. For example, the blockchain node 10a may maintain a node identifier list shown in Table 1, and the node identifier list stores node names and node identifiers of other nodes.

TABLE 1

| Node name | Node identifier |
|---|---|
| Node 10a | AAA.AAA.AAA.AAA |
| Node 10b | BBB.BBB.BBB.BBB |
| Node 10c | CCC.CCC.CCC.CCC |
| Node 10d | DDD.DDD.DDD.DDD |
| . . . | . . . |
| Node 10n | EEE.EEE.EEE.EEE |

The node identifier may be an internet protocol (IP) address and any other piece of information that may be configured for identifying a node in the blockchain network. In Table 1, only the IP address is used as an example for description. For example, the blockchain node 10a may transmit blockchain data (for example, encrypted data packaged into a block format) to the blockchain node 10b through the node identifier BBB.BBB.BBB.BBB, and the blockchain node 10b may determine that the blockchain data is transmitted by the blockchain node 10a through the node identifier AAA.AAA.AAA.AAA.

In the blockchain, before a block is uploaded to a chain, the block is to be passed the consensus node in the blockchain network for consensus. The block can be added to the blockchain only after the consensus is reached. When the blockchain is used in some scenarios of commercial institutions, not all participating nodes in the blockchain (namely, the blockchain nodes in the blockchain network) have sufficient resources and necessity to become the consensus nodes of the blockchain. For example, in the blockchain network shown in FIG. 1, the blockchain node 10a, the blockchain node 10b, the blockchain node 10c, and the blockchain node 10d may be used as the consensus nodes in the blockchain network. The consensus nodes in the blockchain network participate in the consensus, that is, consensus on the block (including a batch of transactions), that is, voting the block; and non-consensus nodes do not participate in the consensus, but help propagate block and voting messages, synchronize state mutually, and the like.

The method provided in some embodiments may be performed by a computer device, and the computer device includes but is not limited to the blockchain node (which may be a client or a server end in some embodiments). In some embodiments, the server end may be an independent physical server, or may be a server cluster including a plurality of physical servers or a distributed system, or may be a cloud server that provides basic cloud computing services such as a cloud database, a cloud service, cloud computing, a cloud function, cloud storage, a network service, cloud communication, a middleware service, a domain name service, a security service, a content delivery network (CDN), a big data, and an artificial intelligence platform. The client mentioned above may be an electronic device, which includes, but is not limited to, a mobile phone, a tablet computer, a desktop computer, a notebook computer, a palmtop computer, a vehicle-mounted device, an augmented reality/virtual reality (AR/VR) device, a helmet display, a smart television, a wearable device, a smart speaker, a digital camera, a camera, and another mobile internet device (MID) having a network access capability, or a terminal device in scenarios such as a train, a ship, and flight.

The embodiments of this application may be applied to various scenarios, including but not limited to scenarios of cloud technologies, artificial intelligence, intelligent transportation, and the like. For example, a blockchain node system may perform a consensus on some driving behavior data, road trajectory data, and the like transmitted by a vehicle-mounted terminal, and upload the driving behavior data, the road trajectory data, and the like for storage after the consensus is reached.

In some embodiments, a plurality of different private key shards may be stored and calculated by a server, a personal computer, a personal wearable intelligent device, or another device (for example, an intelligent car or an intelligent drone) having calculation and storage capabilities. For example, when a service object needs to manage a data asset through an intelligent device of the service object, the service object may initiate a digital asset processing procedure through a personal intelligent car, an intelligent watch, a VR device, or the like, and perform joint calculation based on a local private key shard corresponding to the intelligent device and a private key shard corresponding to another device, to complete a signature.

The computer device described in this application may be a server end or a client, or may be a system including a server end and a client.

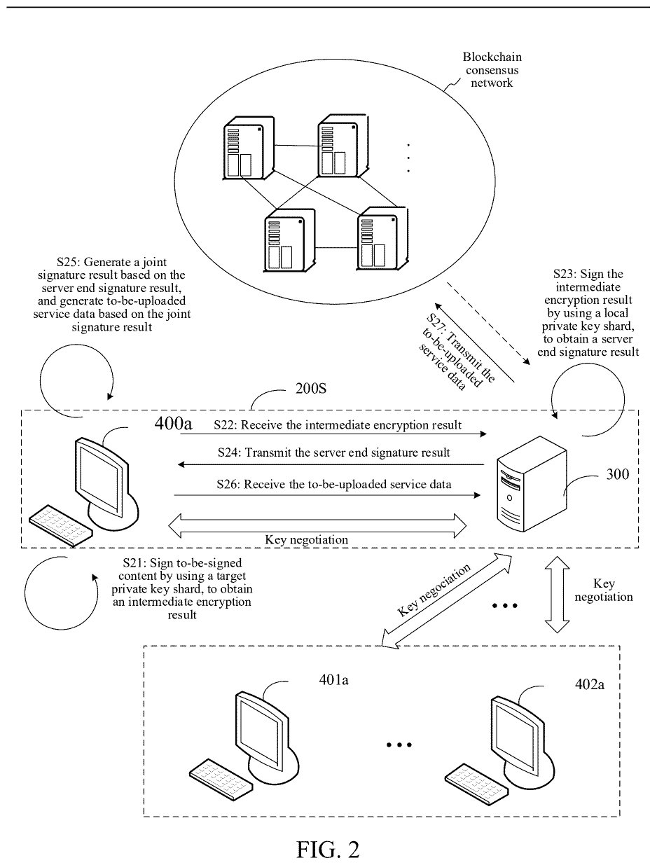

Further, referring to FIG. 2, FIG. 2 is a schematic diagram of a scenario of a digital asset signature according to an embodiment of this application. As shown in FIG. 2, a server 300 may be a backend server (namely, a server end) corresponding to a client on which a payment application is installed in this embodiment, and a service device 400a may be the client on which the payment application is installed in this embodiment. In addition, the server 300 may be the blockchain node 10b in FIG. 1, and the service device 400a may be the blockchain node 10a in FIG. 1. Specifically, the server 300 may obtain communication channels respectively communicating with N clients. The N clients may include the service device 400a. Further, the server 300 may respectively perform key shard negotiation with the N clients based on the N communication channels, to obtain a local private key shard held by the server 300 and a complete public key. For example, the server 300 may perform key shard negotiation with N service devices such as a service device 400a, a service device 401a, . . . , and a service device 402a, to obtain the local private key shard held by the server 300, a first target private key shard held by the service device 400a, a second target private key shard held by the service device 401a, . . . , a third target private key shard held by the service device 402a, and the complete public key. N is a positive integer greater than 1. The complete public key is a unique public key to which the local private key shard and N target private key shards jointly correspond. An i^{th} target private key shard in the N target private key shards is a private key shard held by an i^{th} client in the N clients after the key shard negotiation. In other words, each client can hold only one target private key shard. Further, the server 300 receives signature requests transmitted by M−1 clients in the N clients, and obtains identity association information in the M−1 signature requests. M is a quantity threshold of private key shard for performing signature verification based on the complete public key, and M is a positive integer less than or equal to N+1. Specifically, the quantity threshold of private key shard may be a smallest quantity of private key shards constituting a complete private key corresponding to the complete public key. For example, if a distributed system corresponding to a blockchain service includes one server end and four clients, and a quantity threshold of private key shard of the distributed system is 3, the distributed system needs to generate a complete private key based on private key shards corresponding to three participants (for example, one server end and two clients). In other words, the distributed system cannot generate the complete private key based on private key shards corresponding to two participants. Further, if the identity association information in the M−1 signature requests is legitimate identity information, a client that is in the M−1 clients and that is configured to initiate a blockchain service is determined as a target client, and service execution data associated with the target client is obtained. For example, the service execution data associated with the target client may include transfer data in an application having a payment function. Specifically, the transfer data may include data such as a transfer object, a transfer value, and identity information of the target client. In some embodiments, the service execution data associated with the target client may alternatively be some driving behavior data, road trajectory data, and the like transmitted by a vehicle-mounted terminal. Further, if the service execution data conforms to a risk management policy corresponding to identity association information of the target client, joint signature processing is jointly performed on the blockchain service with the M−1 clients. A joint signature result generated through the joint signature processing is generated based on both the local private key shard and target private key shards respectively held by the M−1 clients, and the joint signature result is configured for being provided for the target client to execute the blockchain service.

A public key and a private key are a key pair (namely, one public key and one private key) obtained by using a key generation algorithm. The public key is a public key part in the key pair, and the private key is a non-public key part in the key pair. Specifically, the public key is usually configured for encrypting data, verifying a digital signature, and the like. The key generation algorithm can ensure that an obtained key pair is unique. When the key pair is used, if one key is used to encrypt a segment of data, the other key needs to be used to decrypt the data. For example, if a segment of data is encrypted by using the public key, the data needs to be decrypted by using the private key. If the data is encrypted by using the private key, the data needs to be decrypted by using the public key. Otherwise, the data cannot be decrypted.

Specifically, an example in which the server 300 and the service device 400a jointly participate in joint signature processing on the blockchain service is used. The data processing method may include at least the following operation S21 to operation S27.

Operation S21: The service device 400a signs to-be-signed content by using a held target private key shard, to obtain an intermediate encryption result.

The to-be-signed content may be service data on which signature confirmation needs to be performed. For example, the service data may be related data of a transfer service in a payment application, for example, including a transfer object, a transfer amount, and a transfer mechanism.

Operation S22: The server 300 receives the intermediate encryption result.

Operation S23: The server 300 signs the intermediate encryption result by using a local private key shard, to obtain a server end signature result.

Operation S24: The server 300 transmits the server end signature result.

Operation S25: The service device 400a generates a joint signature result based on the server end signature result, and generates to-be-uploaded service data based on the to-be-signed content and the joint signature result.

Operation S26: The server 300 receives the to-be-uploaded service data.

Operation S27: The server 300 transmits the to-be-uploaded service data to a blockchain consensus network.

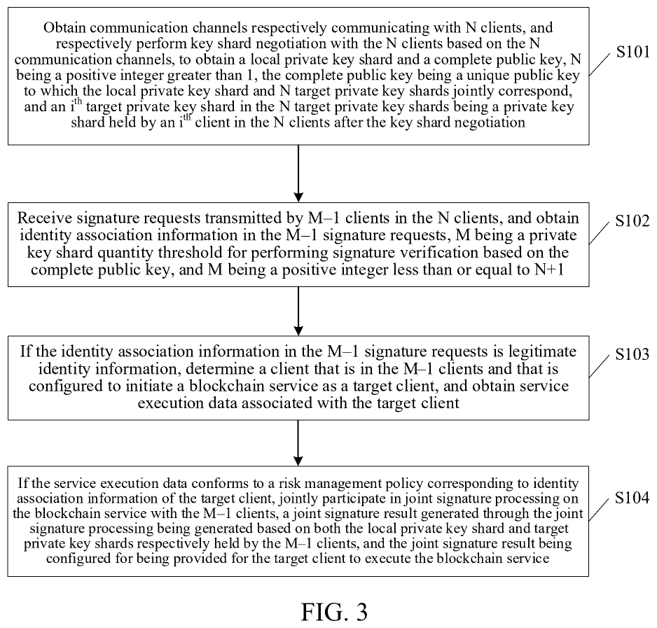

In some embodiments, the server 300 may alternatively receive data in the blockchain consensus network (that is, the server 300 may alternatively be a consensus node in the blockchain consensus network), and perform data processing on the received data. For a specific data processing process, refer to the following detailed descriptions of a process of processing, by a server end, received blockchain service data of a client in FIG. 3.

In a distributed system 200S (namely, a system including the server 300 and the service device 400a), any machine (for example, a server end or a client) may be added to become a node, and one node may correspond to one role (or may be referred to as one object). In other words, the distributed system may be configured to provide a corresponding access interface for a role that joins the blockchain system. For example, corresponding access interfaces may be respectively provided for roles such as a taxation bureau (namely, a tax office), a bill issuance enterprise, a consumer, and a reimbursement enterprise. For example, taxation personnel in the taxation bureau may access a corresponding node by using a target web page in a browser. For another example, when completing a data exchange service by using a target application, the consumer may further access a corresponding node by using a child application (for example, a mini program embedded in a payment application) provided by the target application. Each node may include a hardware layer, an intermediate layer, an operating system layer, and an application layer.

Further, referring to FIG. 3, FIG. 3 is a schematic flowchart of a data processing method according to an embodiment of this application. As shown in FIG. 3, the method may be performed by a server end. The server end may be the blockchain node 10b shown in FIG. 1. This is not limited herein. For ease of understanding, in this embodiment, the method is described by using an example in which the method is performed by the server end. The data processing method may include at least the following operation S101 to operation S104.

Operation S101: Obtain communication channels respectively communicating with N clients, and respectively perform key shard negotiation with the N clients based on the N communication channels, to obtain a local private key shard and a complete public key, N being a positive integer greater than 1, the complete public key being a unique public key to which the local private key shard and N target private key shards jointly correspond, and an i^{th} target private key shard in the N target private key shards being a private key shard held by an i^{th} client in the N clients after the key shard negotiation.

Specifically, the server end may transmit communication messages to the N clients (for example, transmit broadcasts to the N clients) through the communication channels respectively communicating with the N clients. Further, the server end may perform operations such as service negotiation and service request confirmation through the communication channels. The communication channels may be session channels configured for performing sessions between the server end and the clients. In a broad sense, the communication channel may include a virtual channel for communication and a physical channel forming a communication line. For example, the communication channel may include a physical channel such as a transmission cable. Specifically, the communication channel may be a communication channel for a purpose such as broadcasting. For example, in a local area network formed by a communication line, the communication channel may be a virtual line, a hardware line, and the like that form the local area network.

Specifically, a total quantity of clients is not limited in this embodiment. There may be one or more clients, that is, N may be greater than or equal to 1. A specific value of Nis determined by a quantity of participants (namely, blockchain nodes) of a complete private key generation process when a complete private key corresponding to one complete public key is jointly generated in a distributed system corresponding to a blockchain service. An example in which one client and one server end participate in a signature of a payment application is used herein, that is, a service object requests two participants to respectively hold private key shards (namely, one local private key shard and one target private key shard). In other words, the server end may perform key shard negotiation with the client, and generate two separate private key shards (that is, the server end separately holds a local private key shard, and the client separately holds a target private key shard). A generated private key shard is known only inside a device that generates the private key shard, is held by the device that generates the private key shard, and is not published to the outside. The private key shard is a part of a complete private key of the blockchain system (no participant can learn the complete private key). The complete private key includes a plurality of private key shards, the complete private key corresponds to the complete public key, and the complete public key and the private key shard may be generated based on a distributed key generation (DKG) protocol. Specifically, in the DKG protocol, a plurality of participating server ends or clients jointly generate a complete public key and respective private key shards according to a preset encryption system. A complete private key corresponding to the complete public key may be synthesized based on private key shards whose quantity exceeds a particular threshold, but any information about the complete private key cannot be obtained based on private key shards whose quantity is less than the threshold. The complete public key generated based on the DKG protocol is outputted in a public form, and each private key shard is shared by a participant according to a secret sharing solution. The shared private key shard may be used in a group-oriented password system, for example, a group signature or a group decryption. In some embodiments, N may be 2. In other words, an example in which in the distributed system (for example, a distributed system 200S shown in FIG. 2), two clients and one server ends may jointly participate in the signature of the payment application is used, that is, the service object requests three participants to respectively hold private key shards (namely, one local private key shard and two target private key shards). In other words, the server end may perform key shard negotiation with the two clients and generate three independent private key shards (namely, a local private key shard corresponding to the server end and target private key shards respectively corresponding to the two clients). In some embodiments, the key negotiation processing process may further include a threshold signature scheme (TSS) process. In other words, in the key negotiation processing process, the server end may generate a single digital signature from a plurality of signers (blockchain nodes) by using a threshold signature scheme method. Further, a solution of the threshold signature scheme may include a lindell algorithm (a threshold signature scheme algorithm), a DKLS algorithm (a threshold signature scheme algorithm), a CCLST algorithm (a threshold signature scheme algorithm), a GKSS algorithm (a threshold signature scheme algorithm), a GG18 algorithm (a threshold signature scheme algorithm), a GG20 algorithm (a threshold signature scheme algorithm), and the like.

Specifically, the distributed system (for example, a distributed system 200S shown in FIG. 2) may create a key pair by using an asymmetric encryption algorithm. The asymmetric encryption algorithm may include but is not limited to an Elgamal algorithm (an asymmetric encryption algorithm), a Rabin algorithm (an asymmetric encryption algorithm), a Diffie-Hellman algorithm (an asymmetric encryption algorithm), and an elliptic curve cryptography (ECC) algorithm (an elliptic curve encryption algorithm). Specifically, the Diffie-Hellman algorithm is a public-key jiam algorithm based on a discrete logarithm problem, and can enable two nodes to negotiate a common key without sharing any information. Further, a Rivest-Shamir-Adleman (RSA) algorithm is an algorithm in which a public/private key pair is generated based on large prime numbers, and a decryption operation is performed by using these numbers. In addition, the ECC algorithm is a public key encryption algorithm based on an elliptic curve discrete logarithm problem, and has advantages such as a short key length and high security.

Specifically, the server end may randomly generate a local test private key configured for performing key shard negotiation, and perform encryption processing on local negotiation data (the local negotiation data may be random data) by using the local test private key, to obtain local test information. Further, the server end may obtain the communication channels respectively communicating with the N clients, and transmit the local test information to the N clients through each communication channel. Further, the server end may receive target test public keys and target test information that are respectively transmitted by the N clients, and decrypt, by using the target test public keys, target test information belonging to the same client, to obtain N pieces of target decrypted data. One target test public key is a public key that is generated by one client and that corresponds to a target test private key configured for performing key shard negotiation, and one piece of target test information is information obtained by performing encryption processing on target negotiation data by using a generated target test private key in one client. For example, if a pair of keys is generated in a client, and a private key in the pair of keys is a target test private key Z1, a public key in the pair of keys is a target test public key Z2. Based on this, target test information Y is information obtained by performing encryption processing on target negotiation data in the client by using the target test private key Z1. The encrypted information may be transmitted or transferred in a blockchain node system. Further, the server end may decrypt the local test information based on a local test public key corresponding to the local test private key, to obtain local decrypted data, and determine the local decrypted data and the N pieces of target decrypted data as a first hash result. Further, the server end may perform a hash operation on the local negotiation data and N pieces of target negotiation data, to obtain a second hash result. Further, it is determined that key negotiation succeeds if the first hash result is equal to the second hash result, and the local test private key is determined as the local private key shard. Further, the server end may generate the complete public key in a process of performing key shard negotiation with the N clients. By analogy, the N target private key shards held by the clients may also be respectively generated in the N clients by using a method similar to that for generating the local private key shard.

The server end may generate a pseudo-random number at the server end by using a random generation algorithm, and use the pseudo-random number as the local private key shard of the server end. Embodiments of generating the pseudo-random number are not limited. For example, a random number seed (a true random number) is used as an initial condition, and then a random number is generated through continuous iteration by using an algorithm. The server end may perform encryption processing on the local negotiation data by using the local test private key. Specifically, a digital signature algorithm corresponding to the encryption processing may include but is not limited to: ElGamal (a signature algorithm), Fiat-Shamir (a signature algorithm), Guillou-Quisquarter (a signature algorithm), Schnorr (a signature algorithm), Ong-Schnorr-Shamir (a signature algorithm), an elliptic curve digital signature algorithm, a finite automata-based digital signature algorithm, and the like. The local negotiation data is service data that needs to be encrypted in the server end. Correspondingly, each client may perform encryption processing on the target negotiation data by using the target test private key corresponding to each client, to obtain the target test information. The target negotiation data is service data that needs to be encrypted in the client. Further, the target test information belonging to the same client is decrypted by using the target test public key corresponding to each client, to obtain target decrypted data corresponding to each client. If the first hash result is equal to the second hash result, there is no error in a process of encrypting the local negotiation data by using the local test private key, a process of decrypting the local test information by using the local test public key corresponding to the local test private key, a process of encrypting the target negotiation data by using the target test private key, and a process of decrypting the target test information by using the target test public key corresponding to the target test private key.

Further, the server end may generate a target service address based on the complete public key. Further, the server end may obtain to-be-verified addresses respectively transmitted by the N clients. A to-be-verified address transmitted by one client is generated based on the complete public key. Further, if the target service address is the same as the N to-be-verified addresses, it is determined that the target service address is a legitimate address, and the target service address is determined as an application on-chain address. Correspondingly, if there is a to-be-verified address different from the target service address in the N to-be-verified addresses, the target service address and the N to-be-verified addresses that have been generated are deleted, and application on-chain address regeneration requests are transmitted to the N clients. The application on-chain address regeneration request is configured for indicating the N clients to regenerate new to-be-verified addresses based on the complete public key.

Specifically, the server end may perform deduction by using the complete public key, to obtain the target service address. Further, if the target service address is the same as the obtained N to-be-verified addresses, it is determined that the target service address is a legitimate address, and the target service address is determined as an application on-chain address. The application on-chain address is an address of an application (for example, an address of a payment application) corresponding to a blockchain service. For example, if the distributed system 200S in FIG. 2 includes one client and one server end, if a target service address generated by the server end is the same as a to-be-verified address generated by the client, the target service address is an address of an application (for example, a payment application on the client) corresponding to a blockchain service. Further, the target service address may be configured for locating a blockchain data exchange object in a blockchain node network. For example, in this embodiment, after obtaining a complete public key and an address (namely, the target service address) of a game resource account that are transmitted by a game client (namely, the target client), a target node (namely, the server end) may transmit the complete public key and the address of the game resource account to each node in a blockchain network. After receiving the complete public key and the address of the game resource account, any node may exchange game resource-related data (for example, virtual game equipment data that needs to be updated) by using the address of the game resource account. In addition, after receiving the complete public key and the address of the game resource account, the node may further perform consensus processing on the complete public key and the address of the game resource account by using a consensus algorithm and then broadcast the complete public key and the address of the game resource account to the blockchain network again, and continuously perform the consensus processing until public keys and addresses of game resource accounts that are stored in nodes are consistent. In this way, it can be ensured that the public keys and the addresses of the game resource accounts that are stored in the nodes are consistent.

Operation S102: Receive signature requests transmitted by M−1 clients in the N clients, and obtain identity association information in the M−1 signature requests, M being a quantity threshold of private key shard for performing signature verification based on the complete public key, and M being a positive integer less than or equal to N+1.

Specifically, the server end may receive the signature requests transmitted by the M−1 clients in the N clients, to trigger a signature process performed by the server end. Further, the server end may obtain the identity association information in the M−1 signature requests, to perform signature verification on the M−1 clients.

Specifically, the server end may obtain target shard public keys respectively corresponding to the M−1 clients. A target shard public key corresponding to one client is generated based on a target private key shard corresponding to the client. Further, the server end may respectively perform, by using the M−1 target shard public keys, signature verification on shard signature results transmitted by the M−1 clients, to obtain M−1 signature verification results. One shard signature result is data obtained by signing identity association information by one client by using a target private key shard corresponding to the client. Further, if all the M−1 signature verification results are verification success results, legitimate identity verification is performed on the identity association information in the signature requests transmitted by the M−1 clients.

The server end may determine an identity of the client through verification of the target shard public key. Specifically, when generating a local private key shard, the server end may associate a client corresponding to a target private key shard constituting a complete private key with the server end. Therefore, the server end may verify an association relationship between a client and the server end by verifying a target shard public key. In other words, the server end may verify, by verifying the target shard public key, whether the client and the server end belong to a distributed system corresponding to the same complete public key. If all the M−1 signature verification results are the verification success results, it is proved that the server end and the clients corresponding to the M−1 signature verification results have an association relationship. In other words, the server end and the clients corresponding to the M−1 signature verification results may constitute a distributed system belonging to the same complete public key (or the same complete private key).

Further, if the verification succeeds, the server end may perform server end signature processing according to a received signature request. The signature request received by the server end is transmitted by a client on which verification succeeds. Further, for a specific server end signature processing process, reference is made to the following detailed descriptions of operation S103 and operation S104.

Operation S103: If the identity association information in the M−1 signature requests is legitimate identity information, determine a client that is in the M−1 clients and that is configured to initiate a blockchain service as a target client, and obtain service execution data associated with the target client.

Specifically, the M−1 clients corresponding to the M−1 signature requests may include a client Sᵢ, i being a positive integer less than or equal to M−1. Specifically, the server end may obtain service types of blockchain services initiated and associated by the M−1 clients, and obtain an identity identifier and identity feature data in identity association information corresponding to the client Sᵢ. Further, the server end may determine identity verification policies matching the service types, and select, from the identity identifier and the identity feature data, data matching verification dimensions indicated by the identity verification policies as to-be-verified data. Further, if the to-be-verified data exists in an identity database, it is determined that the identity association information in a signature request corresponding to the client Sᵢ is legitimate identity information.

The service type may include operation types such as service querying, transferring, and account management. Specifically, the server may bind an identity identifier and identity feature data when a service object performs account registration. Specifically, the identity feature data may include but is not limited to features corresponding to a plurality of key parts and the like. Specifically, the server end may determine, according to the identity verification policies matching the service types, an identity identifier or identity feature data that needs to be verified. For example, if the server end learns that a service type initiated by a client is service querying (which may be specifically account balance querying), the server end may determine that an identity verification policy matching the service type is verifying identity feature data. Further, the server end may select identity feature data of a service object as data matching a verification dimension indicated by the identity verification policy, that is, the server end may select the identity feature data of the service object as to-be-verified data. Further, if the identity feature data of the service object exists in an identity database, it is determined that the identity association information in the signature request corresponding to the client Sᵢ is the legitimate identity information. A manner in which the server end verifies the identity feature data may be verifying only any one of the plurality of key parts. The verification manner may be set by the service object in the payment application. This is not specifically limited herein. For another example, if the server end learns that a service type initiated by a client is transferring, the server end may determine that an identity verification policy matching the service type is verifying identity feature data and an identity identifier. Further, the server end may select both identity feature data of a service object and an identity identifier of the service object as data matching a verification dimension indicated by the identity verification policy, that is, the server end may select the identity feature data of the service object and the identity identifier of the service object as to-be-verified data. Further, if both the identity feature data of the service object and the identity identifier of the service object exist in the identity database, it is determined that the identity association information in the signature request corresponding to the client Sᵢ is the legitimate identity information. Correspondingly, if any one of the identity feature data of the service object and the identity identifier of the service object does not exist in the identity database, it is determined that the identity association information in the signature request corresponding to the client Sᵢ is illegitimate identity information, and the server end may reject to respond to the transferring service initiated by the client. The foregoing listed identity verification policies are two possible identity verification policies. A specific identity verification policy in this embodiment may be set by a maintenance object of the payment application, and is not specifically limited herein. The rest may be deduced by analogy. For a specific process of determining identity association information of a client other than the client Sᵢ in the M−1 clients, reference may be made to the specific process of determining the identity association information of the client Sᵢ. Details are not described herein again. Further, after verification processing is performed on the identity association information corresponding to the M−1 clients, if it is determined that identity association information corresponding to the M−1 clients is legitimate identity information, it is determined that the identity association information in the M−1 signature requests is the legitimate identity information.

Further, if the identity association information in the M−1 signature requests is the legitimate identity information, the server end may obtain historical service execution data of the target client and target service execution data in the initiated blockchain service, and determine the historical service execution data and the target service execution data as the service execution data associated with the target client. The server end may obtain data such as a historical service interaction record (for example, a historical transaction record) of the target client, a historical setting change of the target client, and a historical service interaction object of the target client, and determine the data as the historical service execution data. The server end may obtain service information of all clients associated with the blockchain service as the target service execution data. Specifically, the server end may determine information such as a service interaction object (for example, a transfer object identifier), service interaction content (for example, a transfer amount), and a service interaction address (for example, an address of a transfer object) as the service information of the client associated with the blockchain service. In other words, the server end may determine the information such as the service interaction object (for example, the transfer object identifier), the service interaction content (for example, the transfer amount), and the service interaction address (for example, the address of the transfer object) as the target service execution data.

Further, the server end may perform data analysis on the historical service execution data in the service execution data to obtain a historical service operation range, and set a service threshold based on the historical service operation range. Further, if the target service execution data in the service execution data is less than or equal to the service threshold, it is determined that the service execution data conforms to the risk management policy corresponding to the identity association information of the target client. For example, if an application corresponding to a client performing service interaction with the server end is a payment application, the server end performs data analysis on historical service execution data in service execution data, where an obtained historical service operation range may be a historical transfer limit of the payment application, and sets a transfer threshold (namely, a service threshold) based on the historical transfer limit of the payment application. Further, if target service execution data (namely, a current transfer limit of the payment application) in the service execution data is less than or equal to the service threshold (namely, the transfer threshold), it is determined that the service execution data conforms to the risk management policy corresponding to the identity association information of the target client. In other words, it is determined that current transfer data of the payment application conforms to the risk management policy corresponding to the identity association information of the target client. For example, the server end may set an upper limit of a single piece of service interaction data within a fixed time period. The fixed time period herein may include an hour, a day, a month, and the like. In some embodiments, the server end may set an upper limit of a quantity of times service interaction data within the fixed time period. In some embodiments, the server end may further perform, for particular scenarios preset by some service objects, a risk management policy that limits blockchain service interaction.

Specifically, the server end may obtain an application on-chain address corresponding to the target client from the service execution data, and perform address risk detection on the application on-chain address. Further, if it is detected that the application on-chain address exists in a legitimate address list, it is determined that the service execution data conforms to the risk management policy corresponding to the identity association information of the target client. Correspondingly, if it is detected that the application on-chain address does not exist in a legitimate address list, it is determined that the application on-chain address is a risky address, and responding to the blockchain service initiated by the target client is prohibited. The server end performs address risk detection on the application on-chain address, so that a blacklist address published by a supervision unit and an address of a control entity can be filtered, thereby reducing a risk of performing digital asset service interaction and improving security of performing digital asset service interaction.

Operation S104: If the service execution data conforms to a risk management policy corresponding to identity association information of the target client, jointly participate in joint signature processing on the blockchain service with the M−1 clients. A joint signature result generated through the joint signature processing is generated based on both the local private key shard and target private key shards respectively held by the M−1 clients, and the joint signature result is configured for being provided for the target client to execute the blockchain service.

Specifically, the M−1 clients include the target client. Specifically, the server end may receive an intermediate encryption result that is transmitted by the target client and that is obtained by performing encryption processing by using a target private key shard corresponding to the target client, and sign the received intermediate encryption result by using the local private key shard, to obtain a server end signature result. Further, the server end may send the server end signature result to the target client. The server end signature result is configured for indicating the target client to generate a joint signature result.

Further, the server end may receive to-be-uploaded service data transmitted by the target client. The to-be-uploaded service data includes target service execution data in the blockchain service and the joint signature result. Further, the server end may forward the to-be-uploaded service data to a blockchain consensus network, so that the blockchain consensus network performs signature verification on the joint signature result based on the complete public key in a consensus process, and when the consensus is reached, store execution result data corresponding to the target service execution data into a blockchain ledger. The blockchain ledger is configured for providing functions of operations such as storage, query, and modification of account data. Recorded data of the operations on the account data is sent to another node in a blockchain system (for example, the distributed system 200S in FIG. 2). The another node stores, after verifying that the account data is valid, the recorded data in a temporary block in response to admitting that the account data is valid, and may further send an acknowledgment to a node that initiates the operations. The node may be a computing device of any form in an access network, for example, a server or a client.

In this embodiment, a ratio of a quantity (namely, one) of private key shards held by the server end to a quantity of all private key shards in the distributed system corresponding to the blockchain service is less than or equal to 50%. In other words, a shard share of the private key shard held by the server end is less than or equal to 50%. This ensures that if a client does not participate in joint signature, the server end cannot independently complete joint signature. Therefore, the server end cannot privately use a digital asset, to reduce a risk probability of using the digital asset.

In one embodiment, blockchain service data such as association data of a payment application is involved. When embodiments of this application are applied to specific products or technologies, collection and processing of related data need to strictly comply with relevant laws and regulations of relevant countries during actual application, informed consent or separate consent (or having a legal basis) of a personal information subject needs to be obtained, and subsequent data is used and processed within the scope of authorization of laws and regulations and the personal information subject. When a human face (or another biometric feature) recognition technology is involved, related data collection, use, and processing processes are to comply with national legal and legal requirements. Before human face information is collected, an information processing rule is to be notified, and individual agreement (or a legal basis) of a target object is to be solicited. The human face information is strictly processed according to the legal and legal requirements and a personal information processing rule, to ensure security of related data by using technical measures.

In some embodiments, communication channels respectively communicating with N clients are obtained, and key shard negotiation is respectively performed with the N clients based on the N communication channels, to obtain a local private key shard and a complete public key. Further, signature requests transmitted by M−1 clients in the N clients are received, and identity association information in the M−1 signature requests is obtained. Further, if the identity association information in the M−1 signature requests is legitimate identity information, a client that is in the M−1 clients and that is configured to initiate a blockchain service is determined as a target client, and service execution data associated with the target client is obtained. Further, if the service execution data conforms to a risk management policy corresponding to identity association information of the target client, joint signature processing is jointly performed on the blockchain service with the M−1 clients. A joint signature result generated through the joint signature processing is generated based on both the local private key shard and target private key shards respectively held by the M−1 clients, and the joint signature result is configured for being provided for the target client to execute the blockchain service. In some embodiments, a local private key shard and a target private key shard are obtained through key shard negotiation, and verification is performed on identity association information of a client or a server end that participates in signature. After the identity association information is verified as legitimate identity information, joint signature processing is performed on multi-end private key shards, and one private key is no longer used alone to perform signature processing on a digital asset, so that a probability of a signature error cause by a private key problem is reduced, and a risk probability when a digital asset is used is reduced. In some embodiments, identity association information verification is performed, so that security confirmation may be performed on identity association information of a client, thereby reducing a risk probability of a signature process. In addition, in some embodiments, address risk detection is performed on the application on-chain address through verification of the risk management policy, so that a blacklist address published by a supervision unit and an address of a control entity can be filtered and intercepted, thereby reducing a risk of performing digital asset service interaction and improving security of performing digital asset service interaction. In some embodiments, a risk probability when a digital asset is used is reduced.

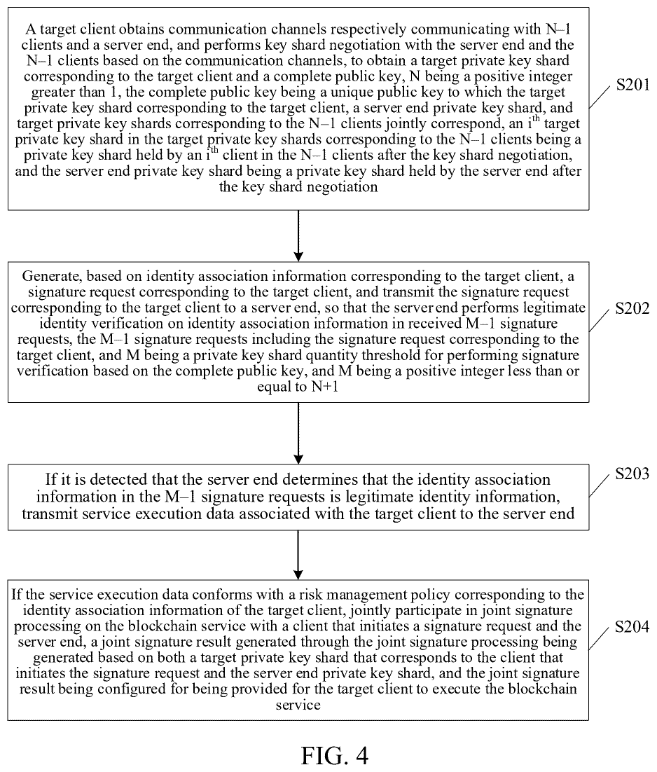

Further, referring to FIG. 4, FIG. 4 is a schematic flowchart of another data processing method according to an embodiment of this application. As shown in FIG. 4, the method may be performed by a client. The client may be any blockchain node in the blockchain node system shown in FIG. 1, for example, the blockchain node 10a. This is not limited herein. For ease of understanding, in this embodiment, the method is described by using an example in which the method is performed by the client. The data processing method may include at least the following operation S201 to operation S204.

Operation S201: A target client obtains communication channels respectively communicating with N−1 clients and a server end, and performs key shard negotiation with the server end and the N−1 clients based on the communication channels, to obtain a target private key shard corresponding to the target client and a complete public key, N being a positive integer greater than 1, the complete public key being a unique public key to which the target private key shard corresponding to the target client, a server end private key shard, and target private key shards corresponding to the N−1 clients jointly correspond, an i^{th} target private key shard in the target private key shards corresponding to the N−1 clients being a private key shard held by an i^{th} client in the N−1 clients after the key shard negotiation, and The server end private key shard being a private key shard held by the server end after the key shard negotiation.

Specifically, the target client may perform a session through the obtained communication channel. Broadcasting and message replying in a key negotiation process are performed through the communication channels. Further, the target client may perform key shard negotiation based on the communication channels, to obtain a unique public key. This operation is a response process in which the client is an execution body. For a specific process, reference may be made to the detailed descriptions of the content corresponding to operation S201 in S101 in which the server end is the execution body in the embodiment corresponding to FIG. 3. Details are not described herein again.

Operation S202: Generate, based on identity association information corresponding to the target client, a signature request corresponding to the target client, and transmit the signature request corresponding to the target client to a server end, so that the server end performs legitimate identity verification on identity association information in received M−1 signature requests, the M−1 signature requests including the signature request corresponding to the target client, and M being a quantity threshold of private key shard for performing signature verification based on the complete public key, and M being a positive integer less than or equal to N+1.

For a specific process of the operation, reference may be made to S102 in the embodiment corresponding to FIG. 3. Details are not described herein again.

Operation S203: If it is detected that the server end determines that the identity association information in the M−1 signature requests is legitimate identity information, transmit service execution data associated with the target client to the server end.

For a specific process of the operation, reference may be made to S103 in the embodiment corresponding to FIG. 3. Details are not described herein again.

Operation S204: If the service execution data conforms to a risk management policy corresponding to the identity association information of the target client, jointly participate in joint signature processing on the blockchain service with a client that initiates a signature request and the server end, a joint signature result generated through the joint signature processing being generated based on both a target private key shard that corresponds to the client that initiates the signature request and the server end private key shard, and the joint signature result being configured for being provided for the target client to execute the blockchain service.

Further, the M−1 clients include the target client and a signing client. Specifically, if the target client receives server end fault information transmitted by the server end, the target client performs encryption processing on obtained to-be-signed information by using the target private key shard corresponding to the target client, to obtain an initial signature result. Further, the target client may transmit the initial signature result to the signing client, so that the signing client performs encryption processing on the initial signature result by using a target private key shard corresponding to the signing client, to obtain a target signature result. Further, the target client may receive the target signature result transmitted by the signing client, and generate the joint signature result based on the target signature result. The target client and the signing client perform joint signature, so that when the server end is permanently unavailable or there is a denial of service on the server end, a digital asset is transferred to a new controllable address for performing a blockchain service, to ensure security of the digital asset and reduce a risk probability when the digital asset is used.

Further, the target client may transmit to-be-uploaded service data to the server end. The to-be-uploaded service data includes target service execution data in the blockchain service and the joint signature result. Further, if signature verification performed by a blockchain consensus network on the joint signature result based on the complete public key succeeds and a consensus on the to-be-uploaded service data is reached, the target client may receive feedback data that is transmitted by the server end and that is for the to-be-uploaded service data, and update and display the virtual resource data on the blockchain function interface based on the feedback data.

Specifically, the target client may display a service initiation control, and an application on-chain address and virtual resource data that correspond to the target client in a blockchain function interface, the virtual resource data being configured for representing service data in a blockchain service account corresponding to the target client. Further, in response to a blockchain service initiation operation of the service initiation control in the blockchain function interface, the target client may transmit, to the server end, the signature request that corresponds to the target client and that is generated based on the identity association information corresponding to the target client, so that the server end performs signature processing. Specifically, for another specific process in which the server end performs signature processing, reference may be made to the detailed descriptions of operation S104 in FIG. 3. Details are not described herein again.

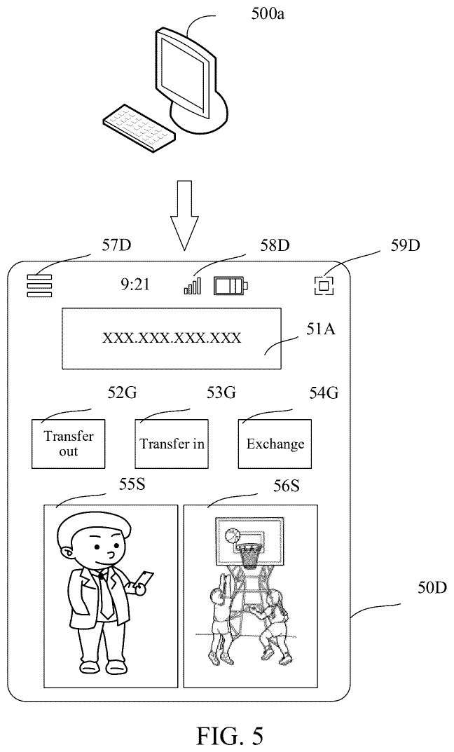

Referring to FIG. 5, FIG. 5 is a schematic diagram of an interface of a target client according to an embodiment of this application. As shown in FIG. 5, a service device 500a may be a client on which a payment application is installed in this embodiment. In addition, the service device 500a may be the blockchain node 10b in FIG. 1. Specifically, in FIG. 5, a client interface 50D is a blockchain function interface, and the client interface 50D may display an application on-chain address 51A corresponding to a target client. For example, the application on-chain address 51A corresponding to the target client may be an address of the client corresponding to the payment application. Further, the client interface 50D may display a control corresponding to a core function. A transfer-out control 52G shown in FIG. 5 may be configured to initiate a process of transferring out an account balance corresponding to the current payment application. Correspondingly, a transfer-in control 53G may be configured to initiate a process of transferring in an account balance corresponding to the current payment application. Correspondingly, an exchange control 54G may be configured to initiate a process of exchanging a digital asset type (for example, a digital asset type commonly used in different regions) of an account balance corresponding to the current payment application. For example, if digital asset types of a region W and a region V are different, an account balance in the payment application may be converted between the digital asset type of the region W and the digital asset type of the region V through the exchange control 54G. Further, the client interface 50D may display virtual resource data. For example, the virtual resource data may be a digital collection 55S and a digital collection 56S shown in FIG. 5. Different digital collections may have different digital collection identifiers. Specifically, a trigger operation may be performed on a region in which the virtual resource data is located, to view another digital collection in the payment application. The trigger operation may include a trigger operation such as tapping/clicking, double-tapping/clicking, long-pressing, zoom-in, or zoom-out. This is not specifically limited herein, and setting of the trigger operation may be set in a function menu 57D on the client interface 50D. Further, the client interface 50D may display the function menu 57D. The function menu 57D is triggered, and functions such as account switching, account copying, account replying, and account hosting corresponding to the payment application may be performed. Specifically, the trigger operation herein may alternatively be the foregoing trigger operation. This is not specifically limited herein. Further, the client interface 50D may display a chain network state 58D, and switching between a chain network is implemented through a trigger operation on a region corresponding to the chain network state 58D. A specific trigger operation thereof is not limited herein. Further, the client interface 50D may display a service initiation control 59D, and a blockchain service operation is initiated by using the service initiation control 59D. For example, the service initiation control 59D may initiate the blockchain service operation through code scanning by using a camera of a hardware device corresponding to the payment application. In addition, the client interface 50D may further display data such as a current time and a battery level of the hardware device corresponding to the payment application.

In this embodiment, the target client obtains communication channels respectively communicating with N−1 clients and a server end, and performs key shard negotiation with the server end and the N−1 clients based on the communication channels, to obtain a target private key shard corresponding to the target client and a complete public key. Further, the target client generates, based on identity association information corresponding to the target client, a signature request corresponding to the target client, and transmits the signature request corresponding to the target client to a server end, so that the server end performs legitimate identity verification on identity association information in received M−1 signature requests. Further, if it is detected that the server end determines that the identity association information in the M−1 signature requests is legitimate identity information, the target client transmits service execution data associated with the target client to the server end. Further, if the service execution data conforms to a risk management policy corresponding to the identity association information of the target client, the target client jointly participates in joint signature processing on the blockchain service with a client that initiates a signature request and the server end. A joint signature result generated through the joint signature processing is generated based on both a target private key shard that corresponds to the client that initiates the signature request and the server end private key shard, and the joint signature result is configured for being provided for the target client to execute the blockchain service. In some embodiments, a local private key shard and a target private key shard are obtained through key shard negotiation, and verification is performed on identity association information of a client or a server end that participates in signature. After the identity association information is verified as legitimate identity information, joint signature processing is performed on multi-end private key shards, and one private key is no longer used alone to perform signature processing on a digital asset, so that a probability of a signature error cause by a private key problem is reduced, and a risk probability when a digital asset is used is reduced. In this embodiment, identity association information verification is performed, so that the server end detects identity information of a client. If the identity information provided by the client does not meet identity information stored in an identity database of the server end, a signature request of the client is intercepted, to improve a degree of security management of the server end in a signature process, and further reduce a risk probability when a digital asset is used. In addition, in some embodiments, address risk detection is performed on the application on-chain address through verification of the risk management policy, so that a blacklist address published by a supervision unit and an address of a control entity can be filtered and intercepted, thereby reducing a risk of performing digital asset service interaction and reducing a risk probability when a digital asset is used. In addition, in this embodiment, if a device problem occurs in the server end, two clients perform signature, so that the faulty server end is bypassed, and signature processing is performed, to improve a capability of a distributed system of a blockchain service to deal with a risk and improve security of the distributed system of the blockchain service. In some embodiments, a risk probability when a digital asset is used is reduced.

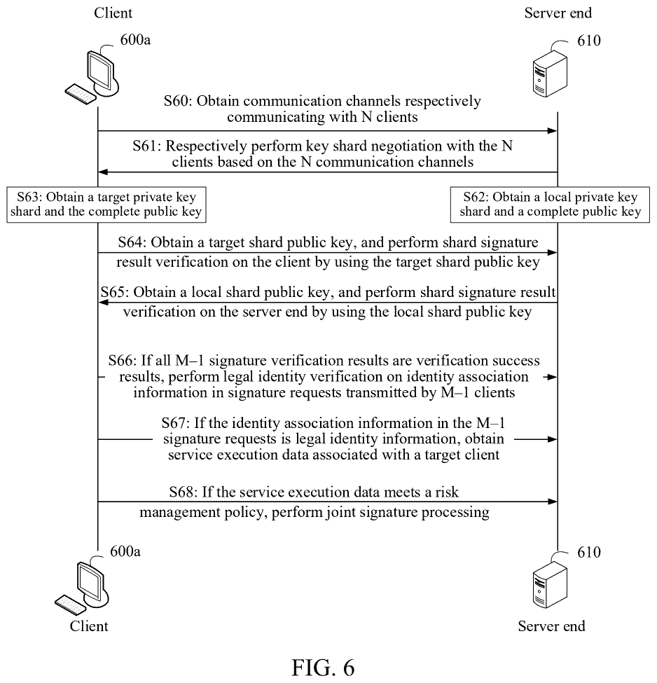

Further, referring to FIG. 6, FIG. 6 is an interaction flowchart of a digital asset signature according to an embodiment of this application. As shown in FIG. 6, the method may be performed by a computer device, and the computer device may include a client 600a or a server end 610 in FIG. 6. Specifically, the client 600a may be any blockchain node in the blockchain node system shown in FIG. 1, for example, the blockchain node 10a, and the server end 610 may be the blockchain node 10b shown in FIG. 1. This is not limited herein. For ease of understanding, in this embodiment, the method is described by using an example in which the method is performed by the computer device. The data processing method may include at least the following operation S60 to operation S68.

Operation S60: Obtain communication channels respectively communicating with N clients.

For a specific process of the operation, reference may be made to S101 in the embodiment corresponding to FIG. 3. Details are not described herein again.

Operation S61: Respectively perform key shard negotiation with the N clients based on the N communication channels.

For a specific process of the operation, reference may be made to S101 in the embodiment corresponding to FIG. 3. Details are not described herein again.

Operation S62: Obtain a local private key shard and a complete public key.

For a specific process of the operation, reference may be made to S101 in the embodiment corresponding to FIG. 3. Details are not described herein again.

Operation S63: Obtain a target private key shard and the complete public key.

For a specific process of the operation, reference may be made to S201 in the embodiment corresponding to FIG. 4. Details are not described herein again.

Operation S64: Obtain a target shard public key, and perform shard signature result verification on a client by using the target shard public key.

For a specific process of the operation, reference may be made to S101 in the embodiment corresponding to FIG. 3. Details are not described herein again.

Operation S65: Obtain a local shard public key, and perform shard signature result verification on a server end by using the local shard public key.

For a specific process of the operation, reference may be made to S201 in the embodiment corresponding to FIG. 4. Details are not described herein again.

Operation S66: If all M−1 signature verification results are verification success results, perform legitimate identity verification on identity association information in signature requests transmitted by M−1 clients.

For a specific process of the operation, reference may be made to S101 in the embodiment corresponding to FIG. 3. Details are not described herein again.

Operation S67: If the identity association information in the M−1 signature requests is legitimate identity information, obtain service execution data associated with a target client.

For a specific process of the operation, reference may be made to S103 in the embodiment corresponding to FIG. 3. Details are not described herein again.

Operation S68: If the service execution data conforms to a risk management policy, perform joint signature processing.

For a specific process of the operation, reference may be made to S104 in the embodiment corresponding to FIG. 3. Details are not described herein again.

In some embodiments, there may be one or more clients, that is, N may be greater than or equal to 1. A specific value of N is determined by a quantity of participants when a service object request a plurality of parties to jointly generate a complete private key corresponding to one complete public key in an application client (for example, a payment application). An example in which four clients and one server end jointly participate in a signature of a payment application is used herein, that is, a service object requests five participants to respectively hold private key shards (namely, one local private key shard and four target private key shards). In other words, the server end may perform key shard negotiation with the four clients and generate five independent private key shards (namely, a local private key shard corresponding to the server end and target private key shards respectively corresponding to the four clients). A generated private key shard is known only inside a device that generates the private key shard, is held by the device that generates the private key shard, and is not published to the outside. If there are three participants meeting a complete private key requirement, the participants may be one server end and two clients. For example, the server end is a service background, and the two clients may be respectively a mobile phone end and a computer end (a pc end). Specifically, for a process of performing joint signature, reference may be made to the joint signature process in FIG. 3 and FIG. 4, and the rest can be deduced by analogy. Details are not described herein again.

In this embodiment, a quantity threshold of private key shard is set, and a centralized risk management policy in which the server end is used as a center is combined, so that the foregoing signature solution has more significant advantages than a signature solution of an existing centralized hosting manner and a signature solution of an existing decentralized hosting manner. The risk management policy on the server end side may reduce a threshold for using an application (for example, a payment application) corresponding to a blockchain service by a service object, and increase convenience of using the application corresponding to the blockchain service. In addition, in this embodiment, the manner of performing joint signature by using the target client and the signing client can ensure autonomy and controllability of a service object for a digital asset, to reduce a risk probability when the digital asset is used.

In some embodiments, communication channels respectively communicating with N clients are obtained, and key shard negotiation is respectively performed with the N clients based on the N communication channels, to obtain a local private key shard and a complete public key. Further, signature requests transmitted by M−1 clients in the N clients are received, and identity association information in the M−1 signature requests is obtained. Further, if the identity association information in the M−1 signature requests is legitimate identity information, a client that is in the M−1 clients and that is configured to initiate a blockchain service is determined as a target client, and service execution data associated with the target client is obtained. Further, if the service execution data conforms to a risk management policy corresponding to identity association information of the target client, the server end jointly participates in joint signature processing on the blockchain service with the M−1 clients. A joint signature result generated through the joint signature processing is generated based on both the local private key shard and target private key shards respectively held by the M−1 clients, and the joint signature result is configured for being provided for the target client to execute the blockchain service. In some embodiments, a local private key shard and a target private key shard are obtained through key shard negotiation, and verification is performed on identity association information of a client or a server end that participates in signature. After the identity association information is verified as legitimate identity information, joint signature processing is performed on multi-end private key shards, and one private key is no longer used alone to perform signature processing on a digital asset, so that a probability of a signature error cause by a private key problem is reduced, and a risk probability when a digital asset is used is reduced. In some embodiments, identity association information verification is performed, so that security confirmation may be performed on identity association information of a client, thereby reducing a risk probability of using a digital asset. In addition, in some embodiments, address risk detection is performed on the application on-chain address through verification of the risk management policy, so that a blacklist address published by a supervision unit and an address of a control entity can be filtered and intercepted, thereby reducing a risk of performing digital asset service interaction. In some embodiments, a risk probability when a digital asset is used is reduced.

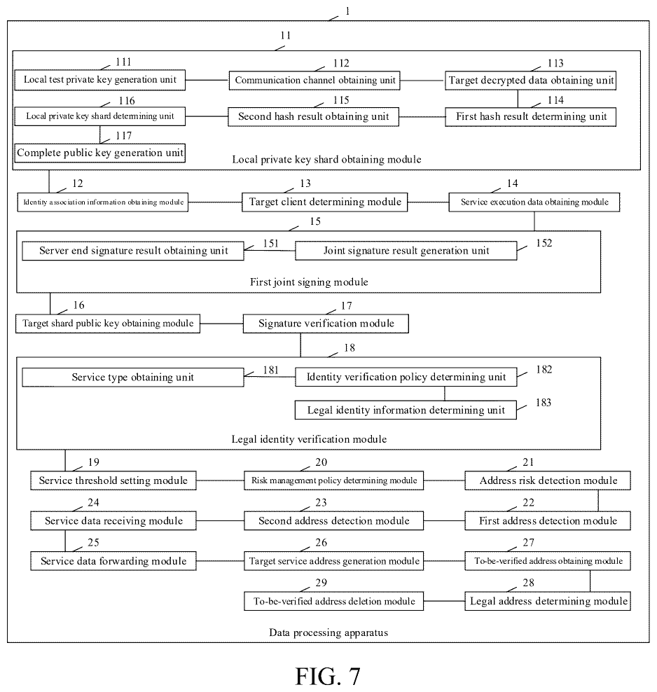

Further, referring to FIG. 7, FIG. 7 is a schematic structural diagram of a data processing apparatus according to an embodiment of this application. The data processing apparatus may be a computer program (including program code) run on a computer device. For example, the data processing apparatus is application software. The apparatus may be configured to perform corresponding operations in the method provided in some embodiments. As shown in FIG. 7, the data processing apparatus 1 is used in a service management platform. The data processing apparatus 1 may include: a local private key shard obtaining module 11, an identity association information obtaining module 12, a target client determining module 13, a service execution data obtaining module 14, and a first joint signing module 15.

The local private key shard obtaining module 11 is configured to obtain communication channels respectively communicating with N clients, and respectively perform key shard negotiation with the N clients based on the N communication channels, to obtain a local private key shard and a complete public key, N being a positive integer greater than 1, the complete public key being a unique public key to which the local private key shard and N target private key shards jointly correspond, and an i^{th} target private key shard in the N target private key shards being a private key shard held by an i^{th} client in the N clients after the key shard negotiation.

The identity association information obtaining module 12 is configured to receive signature requests transmitted by M−1 clients in the N clients, and obtain identity association information in the M−1 signature requests, M being a quantity threshold of private key shard for performing signature verification based on the complete public key, and M being a positive integer less than or equal to N+1.

The target client determining module 13 is configured to: if the identity association information in the M−1 signature requests is legitimate identity information, determine a client that is in the M−1 clients and that is configured to initiate a blockchain service as a target client.

The service execution data obtaining module 14 is configured to obtain service execution data associated with the target client.

The first joint signing module 15 is configured to: if the service execution data conforms to a risk management policy corresponding to identity association information of the target client, jointly participate in joint signature processing on the blockchain service with the M−1 clients, a joint signature result generated through the joint signature processing being generated based on both the local private key shard and target private key shards respectively held by the M−1 clients, and the joint signature result being configured for being provided for the target client to execute the blockchain service.

For embodiments of the local private key shard obtaining module 11, the identity association information obtaining module 12, the target client determining module 13, the service execution data obtaining module 14, and the first joint signing module 15, reference may be made to operation S101 to operation S104 in the embodiment corresponding to FIG. 3. Details are not described herein again.

Referring to FIG. 7 again, the local private key shard obtaining module 11 includes:
a local test private key generation unit 111, configured to randomly generate a local test private key configured for performing key shard negotiation, and perform encryption processing on local negotiation data by using the local test private key, to obtain local test information;
a communication channel obtaining unit 112, configured to obtain the communication channels respectively communicating with the N clients, and transmit the local test information to the N clients through each communication channel;
a target decrypted data obtaining unit 113, configured to receive target test public keys and target test information that are respectively transmitted by the N clients, and decrypt, by using the target test public keys, target test information belonging to a same client, to obtain N pieces of target decrypted data, one target test public key being a public key that is generated by one client and that corresponds to a target test private key configured for performing key shard negotiation, and one piece of target test information being information obtained by performing encryption processing on target negotiation data by using a generated target test private key in one client;
a first hash result determining unit 114, configured to decrypt the local test information based on a local test public key corresponding to the local test private key, to obtain local decrypted data, and determine the local decrypted data and the N pieces of target decrypted data as a first hash result;
a second hash result obtaining unit 115, configured to perform a hash operation on the local negotiation data and N pieces of target negotiation data, to obtain a second hash result;
a local private key shard determining unit 116, configured to determine that key negotiation succeeds if the first hash result is equal to the second hash result, and determine the local test private key as the local private key shard; and
a complete public key generation unit 117, configured to generate the complete public key in a process of performing key shard negotiation with the N clients.

For embodiments of the local test private key generation unit 111, the communication channel obtaining unit 112, the target decrypted data obtaining unit 113, the first hash result determining unit 114, the second hash result obtaining unit 115, the local private key shard determining unit 116, and the complete public key generation unit 117, reference may be made to operation S101 in the embodiment corresponding to FIG. 3. Details are not described herein again.

Referring to FIG. 7 again, the data processing apparatus 1 further includes:
a target shard public key obtaining module 16, configured to obtain target shard public keys respectively corresponding to the M−1 clients, a target shard public key corresponding to one client being generated based on a target private key shard corresponding to the client;
a signature verification module 17, configured to respectively perform, by using the M−1 target shard public keys, signature verification on shard signature results transmitted by the M−1 clients, to obtain M−1 signature verification results, one shard signature result being data obtained by signing identity association information by one client by using a target private key shard corresponding to the client; and
a legitimate identity verification module 18, configured to: if all the M−1 signature verification results are verification success results, perform legitimate identity verification on the identity association information in the signature requests transmitted by the M−1 clients.

For embodiments of the target shard public key obtaining module 16, the signature verification module 17, and the legitimate identity verification module 18, reference may be made to operation S101 in the embodiment corresponding to FIG. 3. Details are not described herein again.

Referring to FIG. 7 again, the M−1 clients include a client Sᵢ, i being a positive integer less than or equal to M−1. The legitimate identity verification module 18 includes:
a service type obtaining unit 181, configured to obtain service types of blockchain services initiated and associated by the M−1 clients, and obtain an identity identifier and identity feature data in identity association information corresponding to the client Sᵢ;
an identity verification policy determining unit 182, configured to determine identity verification policies matching the service types, and select, from the identity identifier and the identity feature data, data matching verification dimensions indicated by the identity verification policies as to-be-verified data; and
a legitimate identity information determining unit 183, configured to: if the to-be-verified data exists in an identity database, determine that the identity association information in a signature request corresponding to the client Sᵢ is legitimate identity information.

For embodiments of the service type obtaining unit 181, the identity verification policy determining unit 182, and the legitimate identity information determining unit 183, reference may be made to operation S101 in the embodiment corresponding to FIG. 3. Details are not described herein again.

Referring to FIG. 7 again, the service execution data obtaining module 14 is specifically configured to obtain historical service execution data of the target client and target service execution data in the initiated blockchain service, and determine the historical service execution data and the target service execution data as the service execution data associated with the target client.

The data processing apparatus 1 further includes:
a service threshold setting module 19, configured to perform data analysis on the historical service execution data in the service execution data to obtain a historical service operation range, and set a service threshold based on the historical service operation range; and
a risk management policy determining module 20, configured to: if the target service execution data in the service execution data is less than or equal to the service threshold, determine that the service execution data conforms to the risk management policy corresponding to the identity association information of the target client.

For embodiments of the service threshold setting module 19 and the risk management policy determining module 20, reference may be made to operation S101 in the embodiment corresponding to FIG. 3. Details are not described herein again.

Referring to FIG. 7 again, the data processing apparatus 1 further includes:
an address risk detection module 21, configured to obtain an application on-chain address corresponding to the target client from the service execution data, and perform address risk detection on the application on-chain address; and
a first address detection module 22, configured to: if it is detected that the application on-chain address exists in a legitimate address list, determine that the service execution data conforms to the risk management policy corresponding to the identity association information of the target client; or
a second address detection module 23, configured to: if it is detected that the application on-chain address does not exist in a legitimate address list, determine that the application on-chain address is a risky address, and prohibit responding to the blockchain service initiated by the target client.

For embodiments of the address risk detection module 21, the first address detection module 22, and the second address detection module 23, reference may be made to operation S101 in the embodiment corresponding to FIG. 3. Details are not described herein again.

Referring to FIG. 7 again, the M−1 clients include the target client. The first joint signing module 15 includes:
a server end signature result obtaining unit 151, configured to receive an intermediate encryption result that is transmitted by the target client and that is obtained by performing encryption processing by using a target private key shard corresponding to the target client, and sign the received intermediate encryption result by using the local private key shard, to obtain a server end signature result; and
a joint signature result generation unit 152, configured to transmit the server end signature result to the target client, the server end signature result being configured for indicating the target client to generate a joint signature result.

For specific functional implementations of the server end signature result obtaining unit 151 and the joint signature result generation unit 152, reference may be made to operation S104 in the embodiment corresponding to FIG. 3. Details are not described herein again.

Referring to FIG. 7 again, the data processing apparatus 1 further includes:
a service data receiving module 24, configured to: receive to-be-uploaded service data transmitted by the target client, the to-be-uploaded service data including target service execution data in the blockchain service and the joint signature result; and
a service data forwarding module 25, configured to forward the to-be-uploaded service data to a blockchain consensus network, so that the blockchain consensus network performs signature verification on the joint signature result based on the complete public key in a consensus process, and when the consensus is reached, store execution result data corresponding to the target service execution data into a blockchain ledger.

For embodiments of the service data receiving module 24 and the service data forwarding module 25, reference may be made to operation S104 in the embodiment corresponding to FIG. 3. Details are not described herein again.

Referring to FIG. 7 again, the data processing apparatus 1 further includes:
a target service address generation module 26, configured to generate a target service address based on the complete public key;
a to-be-verified address obtaining module 27, configured to obtain to-be-verified addresses respectively transmitted by the N clients, a to-be-verified address transmitted by one client being generated based on the complete public key; and
a legitimate address determining module 28, configured to: if the target service address is the same as the N to-be-verified addresses, determine that the target service address is a legitimate address, and determine the target service address as an application on-chain address; or
a to-be-verified address deletion module 29, configured to: if there is a to-be-verified address different from the target service address in the N to-be-verified addresses, delete the target service address and the N to-be-verified addresses that have been generated, and transmit application on-chain address regeneration requests to the N clients, the application on-chain address regeneration request being configured for indicating the N clients to regenerate new to-be-verified addresses based on the complete public key.

For embodiments of the target service address generation module 26, the to-be-verified address obtaining module 27, the legitimate address determining module 28, and the to-be-verified address deletion module 29, reference may be made to operation S104 in the embodiment corresponding to FIG. 3. Details are not described herein again.

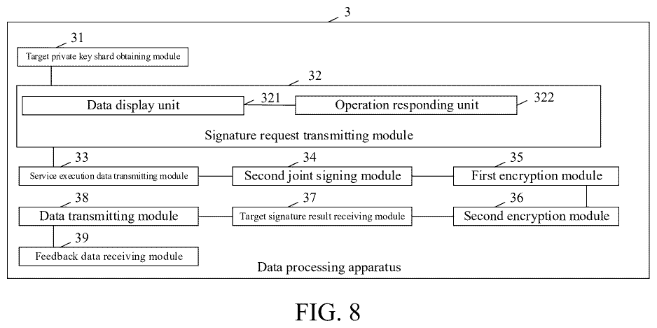

Further, referring to FIG. 8, FIG. 8 is a schematic structural diagram of a data processing apparatus according to an embodiment of this application. The data processing apparatus may be a computer program (including program code) run on a computer device. For example, the data processing apparatus is application software. The apparatus may be configured to perform corresponding operations in the method provided in some embodiments. As shown in FIG. 8, the data processing apparatus 3 is used in a service management platform. The data processing apparatus 3 may include: a target private key shard obtaining module 31, a signature request transmitting module 32, a service execution data transmitting module 33, and a second joint signing module 34.

The target private key shard obtaining module 31 is configured to obtain, by a target client, communication channels respectively communicating with N−1 clients and a server end, and perform key shard negotiation with the server end and the N−1 clients based on the communication channels, to obtain a target private key shard corresponding to the target client and a complete public key, N being a positive integer greater than 1, the complete public key being a unique public key to which the target private key shard corresponding to the target client, a server end private key shard, and target private key shards corresponding to the N−1 clients jointly correspond, an i^{th} target private key shard in the target private key shards corresponding to the N−1 clients being a private key shard held by an i^{th} client in the N−1 clients after the key shard negotiation, and the server end private key shard being a private key shard held by the server end after the key shard negotiation.

The signature request transmitting module 32 is configured to generate, based on identity association information corresponding to the target client, a signature request corresponding to the target client, and transmit the signature request corresponding to the target client to the server end, so that the server end performs legitimate identity verification on identity association information in received M−1 signature requests, the M−1 signature requests including the signature request corresponding to the target client, and M being a quantity threshold of private key shard for performing signature verification based on the complete public key, and M being a positive integer less than or equal to N+1.

The service execution data transmitting module 33 is configured to: if it is detected that the server end determines that the identity association information in the M−1 signature requests is legitimate identity information, transmit service execution data associated with the target client to the server end.

The second joint signing module 34 is configured to: if the service execution data conforms to a risk management policy corresponding to the identity association information of the target client, jointly participate in joint signature processing on the blockchain service with a client that initiates a signature request and the server end, a joint signature result generated through the joint signature processing being generated based on both a target private key shard that corresponds to the client that initiates the signature request and the server end private key shard, and the joint signature result being configured for being provided for the target client to execute the blockchain service.

For embodiments of the target private key shard obtaining module 31, the signature request transmitting module 32, the service execution data transmitting module 33, and the second joint signing module 34, reference may be made to operation S201 to operation S204 in the embodiment corresponding to FIG. 4. Details are not described herein again.

Referring to FIG. 8 again, the M−1 clients include a target client and a signing client. The data processing apparatus 3 further includes:
a first encryption module 35, configured to: if server end fault information transmitted by the server end is received, perform encryption processing on obtained to-be-signed information by using the target private key shard corresponding to the target client, to obtain an initial signature result;
a second encryption module 36, configured to transmit the initial signature result to the signing client, so that the signing client performs encryption processing on the initial signature result by using a target private key shard corresponding to the signing client, to obtain a target signature result; and
a target signature result receiving module 37, configured to receive the target signature result transmitted by the signing client, and generate the joint signature result based on the target signature result.

For embodiments of the first encryption module 35, the second encryption module 36, and the target signature result receiving module 37, reference may be made to operation S201 in the embodiment corresponding to FIG. 4. Details are not described herein again.

The signature request transmitting module 32 includes:
a data display unit 321, configured to display a service initiation control, and an application on-chain address and virtual resource data that correspond to the target client in a blockchain function interface, the virtual resource data being configured for representing service data in a blockchain service account corresponding to the target client; and
an operation responding unit 322, configured to: in response to a blockchain service initiation operation of the service initiation control in the blockchain function interface, transmit, to the server end, the signature request that corresponds to the target client and that is generated based on the identity association information corresponding to the target client.

For embodiments of the data display unit 321 and the operation responding unit 322, reference may be made to operation S202 in the embodiment corresponding to FIG. 4. Details are not described herein again.

The data processing apparatus 3 further includes:
a data transmitting module 38, configured to transmit to-be-uploaded service data to the server end, the to-be-uploaded service data including target service execution data in the blockchain service and the joint signature result; and
a feedback data receiving module 39, configured to: if signature verification performed by a blockchain consensus network on the joint signature result based on the complete public key succeeds and a consensus on the to-be-uploaded service data is reached, receive feedback data that is transmitted by the server end and that is for the to-be-uploaded service data, and update and display the virtual resource data on the blockchain function interface based on the feedback data.

For embodiments of the data transmitting module 38 and the feedback data receiving module 39, reference may be made to operation S201 in the embodiment corresponding to FIG. 4. Details are not described herein again.

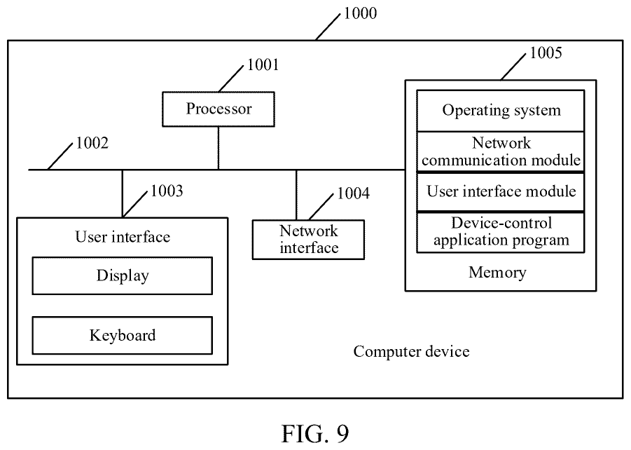

Further, referring to FIG. 9, FIG. 9 is a schematic diagram of a structure of a computer device according to an embodiment of this application. As shown in FIG. 9, the computer device 1000 may include at least one processor 1001 such as a CPU, at least one network interface 1004, a user interface 1003, a memory 1005, and at least one communications bus 1002. The communication bus 1002 is configured to implement connection and communication between these components. The user interface 1003 may include a display, a keyboard, and in some embodiments, the network interface 1004 may include a standard wired interface and a standard wireless interface (for example, a WI-FI interface). The memory 1005 may be a high-speed RAM memory, or may be a non-volatile memory, for example, at least one magnetic disk memory. In some embodiments, the memory 1005 may be at least one storage apparatus located remotely from the foregoing processor 1001. As shown in FIG. 9, the memory 1005 used as a computer storage medium may include an operating system, a network communication module, a user interface module, and a device-control application program.

In the computer device 1000 shown in FIG. 9, the network interface 1004 may provide a network communication function. The user interface 1003 is mainly configured to provide an input interface for a user. The processor 1001 may be configured to invoke a device control application stored in the memory 1005, to implement:
obtaining communication channels respectively communicating with N clients, and respectively performing key shard negotiation with the N clients based on the N communication channels, to obtain a local private key shard and a complete public key, N being a positive integer greater than 1, the complete public key being a unique public key to which the local private key shard and N target private key shards jointly correspond, and an i^{th} target private key shard in the N target private key shards being a private key shard held by an i^{th} client in the N clients after the key shard negotiation; receiving signature requests transmitted by M−1 clients in the N clients, and obtaining identity association information in the M−1 signature requests, M being a quantity threshold of private key shard for performing signature verification based on the complete public key, and M being a positive integer less than or equal to N+1; if the identity association information in the M−1 signature requests is legitimate identity information, determining a client that is in the M−1 clients and that is configured to initiate a blockchain service as a target client, and obtaining service execution data associated with the target client; and if the service execution data conforms to a risk management policy corresponding to identity association information of the target client, jointly participating in joint signature processing on the blockchain service with the M−1 clients, a joint signature result generated through the joint signature processing being generated based on both the local private key shard and target private key shards respectively held by the M−1 clients, and the joint signature result being configured for being provided for the target client to execute the blockchain service.

In the computer device 1000 shown in FIG. 9, the network interface 1004 may provide a network communication function. The user interface 1003 is mainly configured to provide an input interface for a user. The processor 1001 may be configured to invoke a device control application stored in the memory 1005, to implement:
obtaining, by the target client, communication channels respectively communicating with N−1 clients and a server end, and performing key shard negotiation with the server end and the N−1 clients based on the communication channels, to obtain a target private key shard corresponding to the target client and a complete public key, N being a positive integer greater than 1, the complete public key being a unique public key to which the target private key shard corresponding to the target client, a server end private key shard, and target private key shards corresponding to the N−1 clients jointly correspond, an i^{th} target private key shard in the target private key shards corresponding to the N−1 clients being a private key shard held by an i^{th} client in the N−1 clients after the key shard negotiation, and the server end private key shard being a private key shard held by the server end after the key shard negotiation; generating, based on identity association information corresponding to the target client, a signature request corresponding to the target client, and transmitting the signature request corresponding to the target client to the server end, so that the server end performs legitimate identity verification on identity association information in received M−1 signature requests, the M−1 signature requests including the signature request corresponding to the target client, and M being a quantity threshold of private key shard for performing signature verification based on the complete public key, and M being a positive integer less than or equal to N+1; if it is detected that the server end determines that the identity association information in the M−1 signature requests is legitimate identity information, transmitting service execution data associated with the target client to the server end; and if the service execution data conforms to a risk management policy corresponding to the identity association information of the target client, jointly participating in joint signature processing on the blockchain service with a client that initiates a signature request and the server end, a joint signature result generated through the joint signature processing being generated based on both a target private key shard that corresponds to the client that initiates the signature request and the server end private key shard, and the joint signature result being configured for being provided for the target client to execute the blockchain service.

The computer device 1000 described in this embodiment may implement the foregoing descriptions of the data processing method in the embodiments corresponding to FIG. 2, FIG. 3, FIG. 4, FIG. 5, and FIG. 6, or may implement the foregoing descriptions of the data processing apparatus 1 in the embodiment corresponding to FIG. 7 and the data processing apparatus 3 in the embodiment corresponding to FIG. 8. Details are not described herein again. In addition, beneficial effects achieved by using the same method are not described herein again.

An embodiment of this application further provides a computer-readable storage medium. The computer-readable storage medium stores a computer program. The computer program includes program instructions. The program instructions, when being executed by a processor, implement the data processing method provided by the operations in FIG. 2, FIG. 3, FIG. 4, FIG. 5, and FIG. 6. For details, reference may be made to the implementations provided by the operations in FIG. 2, FIG. 3, FIG. 4, FIG. 5, and FIG. 6. Details are not described herein again. In addition, beneficial effects achieved by using the same method are not described herein again.

The computer-readable storage medium may be the data processing apparatus provided in any of the foregoing embodiments or an internal storage unit of the computer device, for example, a hard disk or an internal memory of the computer device. The computer-readable storage medium may be an external storage device of the computer device, for example, a removable hard disk drive, a smart media card (SMC), a secure digital (SD) card, or a flash card equipped on the computer device. Further, the computer-readable storage medium may also include an internal storage unit of the computer device and an external storage device. The computer-readable storage medium is configured to store the computer program and another program and data required by the computer device. The computer-readable storage medium may be further configured to temporarily store data that has been outputted or is to be outputted.

An embodiment of this application further provides a computer program product or a computer program. The computer program product or the computer program includes computer instructions, the computer instructions being stored in a computer-readable storage medium. A processor of a computer device reads the computer instructions from the computer-readable storage medium, and the processor may execute the computer instructions, so that the computer device implements the foregoing descriptions of the data processing method in the embodiments corresponding to FIG. 2, FIG. 3, FIG. 4, FIG. 5, and FIG. 6. Therefore, details are not described herein again. In addition, beneficial effects achieved by using the same method are not described herein again.

Terms “include” and any transformation thereof in the specification, claims, and accompanying drawings in some embodiments are intended to cover non-exclusive including. For example, a process, method, apparatus, product, or device that includes a series of steps or units is not limited to the listed steps or modules, but further includes a step or a module that is not listed, or in some embodiments, includes another step unit that is intrinsic to the process, method, apparatus, product, or device.

A person of ordinary skill in the art may realize that, units and algorithm operations of each example described in combination with the disclosed embodiments herein can be implemented by electronic hardware, computer software, or a combination thereof. To clearly describe the interchangeability between the hardware and the software, compositions and operations of each example have been generally described based on functions in the foregoing descriptions. Whether the functions are performed by hardware or software depends on particular applications and design constraint conditions of the technical solutions. A person skilled in the art may use different methods to implement the described functions for each particular application, but it is not to be considered that the implementation goes beyond the scope of this application.

The method and related apparatus provided in some embodiments are described with reference to the method flowchart and/or the schematic structural diagram provided in some embodiments. Specifically, the computer program instructions implement each process and/or each block in the method flowchart and/or the schematic structural diagram and a combination of a process and/or a block in the flowchart and the block diagram. These computer program instructions may be provided to a general-purpose computer, a dedicated computer, an embedded processor, or a processor of another programmable data processing device to generate a machine, so that the instructions executed by the computer or the processor of the another programmable data processing device generate an apparatus for implementing a specific function in one or more processes in the flowcharts and/or in one or more blocks in the schematic structural diagrams. The computer program instructions may alternatively be stored in a computer-readable memory that can guide a computer or another programmable data processing device to operate in a specific manner, so that the instructions stored in the computer-readable memory generate an artifact including an instruction apparatus. The instruction apparatus implements the functions specified in one or more processes of the flowcharts and/or one or more blocks of the schematic diagrams of the structures. These computer program instructions may also be loaded onto a computer or another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the schematic structural diagrams.

What is disclosed above is merely exemplary embodiments of this application, and certainly is not intended to limit the scope of the claims of this application. Therefore, equivalent variations made in accordance with the claims of this application shall fall within the scope of this application.

What is claimed is:

1. A blockchain key-based data processing method, comprising:
obtaining communication channels respectively communicating with N clients, and respectively performing key shard negotiation with the N clients based on the N communication channels, to obtain a local private key shard and a complete public key, N being a positive integer greater than 1, the complete public key being a unique public key corresponding to the local private key shard and N target private key shards, and an i^{th} target private key shard in the N target private key shards being a private key shard held by an i^{th} client in the N clients after the key shard negotiation;
receiving signature requests transmitted by M−1 clients in the N clients, and obtaining identity association information in the M−1 signature requests, M being a quantity threshold of private key shard for performing signature verification based on the complete public key, and M being a positive integer less than or equal to N+1;
if the identity association information in the M−1 signature requests is legitimate identity information, determining a client that is in the M−1 clients and that is configured to initiate a blockchain service as a target client, and obtaining service execution data associated with the target client; and
if the service execution data conforms to a risk management policy corresponding to identity association information of the target client, jointly participating in joint signature processing on the blockchain service with the M−1 clients, a joint signature result being generated based on both the local private key shard and target private key shards respectively held by the M−1 clients, and the joint signature result being configured for the target client to execute the blockchain service.

2. The method according to claim 1, further comprising:
obtaining target shard public keys respectively corresponding to the M−1 clients, a target shard public key corresponding to one client being generated based on a target private key shard corresponding to the client;
respectively performing, by using the M−1 target shard public keys, signature verification on shard signature results transmitted by the M−1 clients, to obtain M−1 signature verification results, one shard signature result being data obtained by signing identity association information by one client by using a target private key shard corresponding to the client; and
if all the M−1 signature verification results are verification success results, performing legitimate identity verification on the identity association information in the signature requests transmitted by the M−1 clients.

3. The method according to claim 1, wherein the M−1 clients comprise a client Sᵢ, i being a positive integer less than or equal to M−1; and the performing legitimate identity verification on the identity association information in the signature requests transmitted by the M−1 clients comprises:
obtaining service types of blockchain services initiated and associated by the M−1 clients, and obtaining an identity identifier and identity feature data in identity association information corresponding to the client Sᵢ;
determining identity verification policies matching the service types, and selecting, from the identity identifier and the identity feature data, data matching verification dimensions indicated by the identity verification policies as to-be-verified data; and
if the to-be-verified data exists in an identity database, determining that the identity association information in a signature request corresponding to the client Sᵢ is legitimate identity information.

4. The method according to claim 1, wherein the obtaining service execution data associated with the target client comprises:
obtaining historical service execution data of the target client and target service execution data in the initiated blockchain service, and determining the historical service execution data and the target service execution data as the service execution data associated with the target client; and
the method further comprises:
performing data analysis on the historical service execution data in the service execution data to obtain a historical service operation range, and setting a service threshold based on the historical service operation range; and
if the target service execution data in the service execution data is less than or equal to the service threshold, determining that the service execution data conforms to the risk management policy corresponding to the identity association information of the target client.

5. The method according to claim 1, further comprising:
obtaining an application on-chain address corresponding to the target client from the service execution data, and performing address risk detection on the application on-chain address; and
if the application on-chain address exists in a legitimate address list, determining that the service execution data conforms to the risk management policy corresponding to the identity association information of the target client; or
if the application on-chain address does not exist in a legitimate address list, determining that the application on-chain address is a risky address, and prohibiting responding to the blockchain service initiated by the target client.

6. The method according to claim 1, wherein the jointly participating in joint signature processing on the blockchain service with the M−1 clients comprises:
receiving an intermediate encryption result that is transmitted by the target client and that is obtained by performing encryption processing by using a target private key shard corresponding to the target client, and signing the received intermediate encryption result by using the local private key shard, to obtain a server end signature result; and
transmitting the server end signature result to the target client, the server end signature result being configured for indicating the target client to generate a joint signature result.

7. The method according to claim 1, further comprising:
receiving to-be-uploaded service data transmitted by the target client, the to-be-uploaded service data comprising the target service execution data in the blockchain service and the joint signature result; and
forwarding the to-be-uploaded service data to a blockchain consensus network, so that the blockchain consensus network performs signature verification on the joint signature result based on the complete public key in a consensus process, and when the consensus is reached, storing execution result data corresponding to the target service execution data into a blockchain ledger.

8. The method according to claim 1, further comprising:
generating a target service address based on the complete public key;
obtaining to-be-verified addresses respectively transmitted by the N clients, a to-be-verified address transmitted by one client being generated based on the complete public key; and
if the target service address is the same as the N to-be-verified addresses, determining that the target service address is a legitimate address, and determining the target service address as an application on-chain address; or
if there is a to-be-verified address different from the target service address in the N to-be-verified addresses, deleting the target service address and the N to-be-verified addresses that have been generated, and transmitting application on-chain address regeneration requests to the N clients, the application on-chain address regeneration request indicating the N clients to regenerate new to-be-verified addresses based on the complete public key.

9. The method according to claim 1, wherein the obtaining communication channels respectively communicating with N clients, and respectively performing key shard negotiation with the N clients based on the N communication channels, to obtain a local private key shard and a complete public key comprises:
randomly generating a local test private key configured for performing key shard negotiation, and performing encryption processing on local negotiation data by using the local test private key, to obtain local test information;
obtaining the communication channels respectively communicating with the N clients, and transmitting the local test information to the N clients through each communication channel;
receiving target test public keys and target test information that are respectively transmitted by the N clients, and decrypting, by using the target test public keys, target test information belonging to a same client, to obtain N pieces of target decrypted data, one target test public key being a public key that is generated by one client and that corresponds to a target test private key configured for performing key shard negotiation, and one piece of target test information being information obtained by performing encryption processing on target negotiation data by using a generated target test private key in one client;
decrypting the local test information based on a local test public key corresponding to the local test private key, to obtain local decrypted data, and determining the local decrypted data and the N pieces of target decrypted data as a first hash result;
performing a hash operation on the local negotiation data and N pieces of target negotiation data, to obtain a second hash result;
determining that key negotiation succeeds if the first hash result is equal to the second hash result, and determining the local test private key as the local private key shard; and
generating the complete public key in a process of performing key shard negotiation with the N clients.

10. A blockchain key-based data processing method, performed by a target client configured to initiate a blockchain service, and the method comprising:
obtaining, by the target client, communication channels respectively communicating with N−1 clients and a server end, and performing key shard negotiation with the server end and the N−1 clients based on the communication channels, to obtain a target private key shard corresponding to the target client and a complete public key, N being a positive integer greater than 1, the complete public key being a unique public key to which the target private key shard corresponding to the target client, a server end private key shard, and target private key shards corresponding to the N−1 clients jointly correspond, an i^{th} target private key shard in the target private key shards corresponding to the N−1 clients being a private key shard held by an i^{th} client in the N−1 clients after the key shard negotiation, and the server end private key shard being a private key shard held by the server end after the key shard negotiation;
generating, based on identity association information corresponding to the target client, a signature request corresponding to the target client, and transmitting the signature request corresponding to the target client to the server end, so that the server end performs legitimate identity verification on identity association information in received M−1 signature requests, the M−1 signature requests comprising the signature request corresponding to the target client, and M being a quantity threshold of private key shard for performing signature verification based on the complete public key, and M being a positive integer less than or equal to N+1;
if the server end determines that the identity association information in the M−1 signature requests is legitimate identity information, transmitting service execution data associated with the target client to the server end; and
if the service execution data conforms to a risk management policy corresponding to the identity association information of the target client, jointly participating in joint signature processing on the blockchain service with a client that initiates a signature request and the server end, a joint signature result generated through the joint signature processing being generated based on both a target private key shard that corresponds to the client that initiates the signature request and the server end private key shard, and the joint signature result being configured for being provided for the target client to execute the blockchain service.

11. The method according to claim 10, wherein the M−1 clients comprise the target client and a signing client; and the method further comprises:
if server end fault information transmitted by the server end is received, performing encryption processing on obtained to-be-signed information by using the target private key shard corresponding to the target client, to obtain an initial signature result;
transmitting the initial signature result to the signing client, so that the signing client performs encryption processing on the initial signature result by using a target private key shard corresponding to the signing client, to obtain a target signature result; and
receiving the target signature result transmitted by the signing client, and generating the joint signature result based on the target signature result.

12. The method according to claim 10, wherein the generating, based on identity association information corresponding to the target client, a signature request corresponding to the target client, and transmitting the signature request corresponding to the target client to the server end comprises:
displaying a service initiation control, and an application on-chain address and virtual resource data that correspond to the target client in a blockchain function interface, the virtual resource data being configured for representing service data in a blockchain service account corresponding to the target client; and
in response to a blockchain service initiation operation of the service initiation control in the blockchain function interface, transmitting, to the server end, the signature request that corresponds to the target client and that is generated based on the identity association information corresponding to the target client; and
the method further comprises:
transmitting to-be-uploaded service data to the server end, the to-be-uploaded service data comprising target service execution data in the blockchain service and the joint signature result; and
if signature verification performed by a blockchain consensus network on the joint signature result based on the complete public key succeeds and a consensus on the to-be-uploaded service data is reached, receiving feedback data that is transmitted by the server end and that is for the to-be-uploaded service data, and updating and displaying the virtual resource data on the blockchain function interface based on the feedback data.

13. A computer device, comprising a processor, a memory, and a network interface, the processor being connected to the memory and the network interface, the network interface being configured to provide a data communication function, the memory being configured to store a computer program, and the processor being configured to invoke the computer program, to enable the computer device to perform a blockchain key-based data processing method, comprising:
obtaining communication channels respectively communicating with N clients, and
respectively performing key shard negotiation with the N clients based on the N communication channels, to obtain a local private key shard and a complete public key, N being a positive integer greater than 1, the complete public key being a unique public key corresponding to the local private key shard and N target private key shards, and an i^{th} target private key shard in the N target private key shards being a private key shard held by an i^{th} client in the N clients after the key shard negotiation;
receiving signature requests transmitted by M−1 clients in the N clients, and obtaining identity association information in the M−1 signature requests, M being a quantity threshold of private key shard for performing signature verification based on the complete public key, and M being a positive integer less than or equal to N+1;
if the identity association information in the M−1 signature requests is legitimate identity information, determining a client that is in the M−1 clients and that is configured to initiate a blockchain service as a target client, and obtaining service execution data associated with the target client; and
if the service execution data conforms to a risk management policy corresponding to identity association information of the target client, jointly participating in joint signature processing on the blockchain service with the M−1 clients, a joint signature result being generated based on both the local private key shard and target private key shards respectively held by the M−1 clients, and the joint signature result being configured for the target client to execute the blockchain service.

14. The computer device according to claim 13, further comprising:
obtaining target shard public keys respectively corresponding to the M−1 clients, a target shard public key corresponding to one client being generated based on a target private key shard corresponding to the client;
respectively performing, by using the M−1 target shard public keys, signature verification on shard signature results transmitted by the M−1 clients, to obtain M−1 signature verification results, one shard signature result being data obtained by signing identity association information by one client by using a target private key shard corresponding to the client; and
if all the M−1 signature verification results are verification success results, performing legitimate identity verification on the identity association information in the signature requests transmitted by the M−1 clients.

15. The computer device according to claim 13, wherein the M−1 clients comprise a client Sᵢ, i being a positive integer less than or equal to M−1; and the performing legitimate identity verification on the identity association information in the signature requests transmitted by the M−1 clients comprises:
obtaining service types of blockchain services initiated and associated by the M−1 clients, and obtaining an identity identifier and identity feature data in identity association information corresponding to the client Sᵢ;
determining identity verification policies matching the service types, and selecting, from the identity identifier and the identity feature data, data matching verification dimensions indicated by the identity verification policies as to-be-verified data; and
if the to-be-verified data exists in an identity database, determining that the identity association information in a signature request corresponding to the client Sᵢ is legitimate identity information.

16. The computer device according to claim 13, wherein the obtaining service execution data associated with the target client comprises:
obtaining historical service execution data of the target client and target service execution data in the initiated blockchain service, and determining the historical service execution data and the target service execution data as the service execution data associated with the target client; and
the method further comprises:
performing data analysis on the historical service execution data in the service execution data to obtain a historical service operation range, and setting a service threshold based on the historical service operation range; and
if the target service execution data in the service execution data is less than or equal to the service threshold, determining that the service execution data conforms to the risk management policy corresponding to the identity association information of the target client.

17. The computer device according to claim 13, further comprising:
obtaining an application on-chain address corresponding to the target client from the service execution data, and performing address risk detection on the application on-chain address; and
if the application on-chain address exists in a legitimate address list, determining that the service execution data conforms to the risk management policy corresponding to the identity association information of the target client; or
if the application on-chain address does not exist in a legitimate address list, determining that the application on-chain address is a risky address, and prohibiting responding to the blockchain service initiated by the target client.

18. The computer device according to claim 13, wherein the jointly participating in joint signature processing on the blockchain service with the M−1 clients comprises:
receiving an intermediate encryption result that is transmitted by the target client and that is obtained by performing encryption processing by using a target private key shard corresponding to the target client, and signing the received intermediate encryption result by using the local private key shard, to obtain a server end signature result; and
transmitting the server end signature result to the target client, the server end signature result being configured for indicating the target client to generate a joint signature result.

19. The computer device according to claim 13, further comprising:
receiving to-be-uploaded service data transmitted by the target client, the to-be-uploaded service data comprising the target service execution data in the blockchain service and the joint signature result; and
forwarding the to-be-uploaded service data to a blockchain consensus network, so that the blockchain consensus network performs signature verification on the joint signature result based on the complete public key in a consensus process, and when the consensus is reached, storing execution result data corresponding to the target service execution data into a blockchain ledger.

20. The computer device according to claim 13, further comprising:
generating a target service address based on the complete public key;
obtaining to-be-verified addresses respectively transmitted by the N clients, a to-be-verified address transmitted by one client being generated based on the complete public key; and
if the target service address is the same as the N to-be-verified addresses, determining that the target service address is a legitimate address, and determining the target service address as an application on-chain address; or
if there is a to-be-verified address different from the target service address in the N to-be-verified addresses, deleting the target service address and the N to-be-verified addresses that have been generated, and transmitting application on-chain address regeneration requests to the N clients, the application on-chain address regeneration request indicating the N clients to regenerate new to-be-verified addresses based on the complete public key.
